(19) United States
(12) Patent Application Publication
(10) Pub. No.: US 2026/0158462 A1
(43) Pub. Date: Jun. 11, 2026

(54) A GAS-PARTICLE PROCESSOR

(71) Applicant: APRIL PTY LTD, Hawthron, Victoria (AU)

(72) Inventors: Marko TRIFUNOVICH, Hawthorn, Victoria (AU); Andrew Mark LATHAM, Hawthorn, Victoria (AU); Eric Norman CURTIS, Hawthorn, Victoria (AU); David Frederick FLETCHER, Hawthorn, Victoria (AU); Andrew Forbes Alexander HOADLEY, Ivanhoe, Victoria (AU); Caecilia Margaret POTTER, Hawthorn, Victoria (AU); Owen Edward POTTER, Hawthorn, Victoria (AU)

(21) Appl. No.: 18/864,830

(22) PCT Filed: May 12, 2023
(86) PCT No.: PCT/AU2023/050405

§ 371 Date: Nov. 11, 2024

(30) Foreign Application Priority Data
May 13, 2022 (AU) 2022901290

(51) Int. Cl. B01J 8/12; B01J 8/00; F26B 3/14; F26B 17/12

(52) U.S. Cl. CPC B01J 8/12; B01J 8/006; F26B 3/14; F26B 17/122; F26B 2200/08

(57) ABSTRACT

A gas-particle processor for contacting a particle stream with a gas stream comprising: a chamber; at least one gas inlet to introduce gas into the chamber, the gas forming an acceleration gas stream and a main gas stream in the chamber; a particle feeder in fluid communication with a particle inlet to introduce a particle stream into the gas; and a separator to separate the acceleration gas stream from the main gas stream in at least part of the chamber, wherein the acceleration gas stream has a higher average velocity than the main gas stream to form a curtain of the particle stream having an upstream edge and a downstream edge; and a particle outlet for receiving the curtain of the particle stream.

### TECHNICAL FIELD

The present invention relates to methods and apparatuses for the processing of particles with a gas.

The present invention relates particularly, although by no means exclusively, to methods and apparatuses for achieving one of more of heat transfer, mass transfer and a chemical reaction between particles and a gas.

The present invention relates particularly, although by no means exclusively, to methods and apparatuses for the drying of particles using a gas stream.

The present invention also relates, although by no means exclusively, to methods and apparatuses for the coating and drying of particles using a gas stream.

### BACKGROUND

Gas-particle processors such as fluidised beds have a range of applications ranging from fluid catalysed cracking, flue gas cleaning and roasting of mineral ores.

However, one problem faced by gas-particle processes is insufficient distribution of contact of the particle stream by the gas stream, which consequently, results in a reduction in overall heat and/or mass transfer between the two streams and/or inter-phase reaction. Other problems faced by gas-particle processes include difficult in precise control of either or both gas and particle streams and high pressure drop.

Another drawback of fluidised beds and rotary drum gas-particle processors is that they may damage the particles due to prolonged exposure to mechanical and heat stresses.

Therefore, it is desirable to provide a gas-particle processor with improved fluid and particle dynamics.

### SUMMARY OF THE INVENTION

The applicant developed a method and apparatus of feeding particles into a gas-particle processor in such a way that the gas and particle streams interact to form one or more curtains of particles in the chamber of the processor. This method and apparatus are described in International Publication No. WO 2012/068631 which is incorporated herein by cross-reference.

The particles enter the chamber from a feeding aperture and contact a generally horizontal gas stream to form a curtain of particles. The particle trajectory is composed of a horizontal and vertical component and the flow regime of the particles transitions as the particles fall through the top of the curtain. Due to the changing particle flow regime, it is difficult to get uniform distribution of particles in the curtain for effective gas-particle contact. During the course of experimentation, the applicant observed that the particles in the upstream or leading edge of the curtain fall more vertically rather than horizontally. Without being bound by theory, it was believed that this observation was due to the gas stream failing to penetrate the particle curtain.

It is believed that the particle curtain interferes with the horizontal passage of the gas stream. Instead of the gas at the top of the curtain following horizontal streamlines through the curtain, the top of the falling stream of particles acts as a barrier to the horizontal gas flow. This induces the downward flow of gas in the curtain as the gas is diverted towards a more porous part of the curtain to flow through and escapes downstream.

It was realised that the shape and size of the curtain are two factors that influence heat transfer effectiveness.

Investigations by the applicant led to the realisation that the particle curtain is impacted by forces such as pressure gradients and induced flow dynamics, and that the heat and/or mass transfer and/or chemical reaction between the particle and gas streams may be optimised by manipulating the curtain shape and size. This improves the properties of and interaction between the gas and particle streams such as for example, straightness of the gas flow, a higher effective surface area per unit volume of particles in a curtain and particle residence time.

The applicant is seeking to reduce pneumatic conveying behaviour where the particles start flowing horizontally through the chamber in the direction of the main gas flow and increase cross-flow contact of the gas with the particle.

Further investigations by the applicant also led to the realisation that the acceleration gas stream may play an important role in maintaining the shape and size of the curtain to achieve improved heat and/or mass transfer and/or chemical reaction, particularly because the acceleration gas can be used to direct the particles so that they are introduced at an angle to the vertical into the chamber. The acceleration gas may also have a role in keeping the gas streamlines of both the acceleration and main gases as perpendicular as possible, increasing the average slip velocity inside the curtain.

The present invention provides a gas-particle processor for contacting a particle stream with a gas stream comprising:
a chamber;
at least one gas inlet to introduce a gas stream into the chamber, the gas forming an acceleration gas stream and a main gas stream in the chamber;
a particle feeder in fluid communication with a particle inlet to introduce a particle stream into the gas;
a separator to separate the acceleration gas stream from the main gas stream in at least part of the chamber, wherein the acceleration gas stream has a higher average velocity than the main gas stream to form a curtain of the particle stream having an upstream edge and a downstream edge; and
a particle outlet for receiving the curtain of the particle stream.

In this specification, the term “particles” include solid particles and liquid particles in the form of droplets or thin sheets for example.

In this specification, the term “curtain” is understood herein to mean the region of a gas-particle contactor occupied by the particles falling with the vertical component of their particle velocity as they contact the horizontal gas stream. The particle curtain includes finer/smaller-sized particles that tend to concentrate towards the downstream (trailing) edge of the curtain and coarser/larger-sized particles that tend to concentrate towards the upstream (leading) edge of the curtain. The majority (greater than 50%) of the particles in the curtain can be collected at the particle outlet at the bottom of the processor.

In this specification, the term “separator” is understood herein to include any term such as partition, tongue, flange, baffle, divider, etc that functions as a tool to split a total gas flow into two gas flows.

The separator is positioned in the chamber to maintain the different velocities of the acceleration gas stream and the main gas stream. The separator may separate a gas stream into the acceleration gas stream and the main gas stream having different velocities.

The separator may be positioned before and/or after a particle inlet.

The separator may be located upstream or downstream of a particle outlet. This separates the gas prior to contacting a re-introduced curtain of the particle stream or a curtain of fresh feed particles into the gas stream to form another curtain of particles having an upstream edge and a downstream edge.

The separator may be positioned to provide an acceleration gas zone having a height of at least 0.05 m, typically ranging from 0.05 to 1 m.

The separator may be positioned to provide a clearance angle that is greater than 20°, typically from 30 to 90°, more typically 70 to 90°, and even more typically 85 to 90°.

The clearance angle is defined by the following equation:

$$Clearance angle ( θ ) = {tan}^{- 1} ( \frac{Acceleration zone height ( m )}{Separator protrusion ( m )} ) ,$$

wherein the separator protrusion is the length of a separator projecting into a particle inlet.

The separator may have a solid construction. In this embodiment, the separator does not include perforations that allow fluid flow through the separator.

The separator may have perforations. In this embodiment, the perforations allow fluid flow through the separator. Typically, the perforations are sized to allow particles to pass through them. The perforations may have a diameter of at least 0.1 mm, typically at least 1 mm, more typically at least 10 mm.

The area of the perforations may be at least 5% the area of the separator. The area of the perforations may be 20 to 80% the area of the separator.

The applicant discovered that directing the particle stream initially into a first gas stream having a higher velocity before having the particles enter a second gas stream having a lower velocity improves the distribution of the particles in the curtain. It was observed that adopting this method of feeding the particles into the gas stream increases the distribution at the top of the falling stream of particles which would otherwise act as a barrier to the horizontal gas flow and induce a downward flow of gas in the curtain as the gas is diverted towards a more porous part of the curtain to flow through and escapes downstream.

Gas may be introduced into the chamber using one gas inlet and divided into the acceleration gas stream and the main gas stream. Alternatively, separate acceleration gas and main gas streams may be introduced into the chamber. Suitably, the acceleration gas stream is introduced into a region of the chamber above the separator and the main gas stream is introduced into a region of the chamber below the separator.

The acceleration gas stream may flow through an upper region of the chamber.

The acceleration gas stream and the main gas stream may be introduced separately into the chamber.

The gas-particle processor may include multiple gas inlets and multiple particle inlets.

The gas-particle processor may include least two pairs of particle inlets and outlets, wherein the first particle outlet is in fluid communication with the second particle inlet.

In one embodiment, at least two curtains of particles are formed in which the first curtain is formed between the first pair of particle inlet and outlet and the second curtain is formed between the second pair of particle inlet and outlet. In other words, the second particle inlet reintroduces the first curtain into the chamber as the second curtain.

In another embodiment, the first and second particle inlets may not be arranged in chronological order. For example, the first and second particle inlets may be positioned in a reverse cascade order in which the first particle inlet is located after the second particle inlet. This may allow optimisation of the temperature/concentration driving force.

The gas inlets and particle inlets may be configured to introduce the gas streams and the particle streams in a cross-flow arrangement.

In this specification, the term “cross-flow” is understood herein to include contact between a gas stream and a particle stream wherein the particle and gas streams flow in different directions. This encompasses contact between the particle and gas streams in a perpendicular direction and in a non-perpendicular direction as long as the particle and gas streams do not travel in the same direction.

The at least one gas inlet may be positioned to introduce gas in a substantially horizontal direction into the chamber.

The particle inlet may be configured to deliver the particle stream in a substantially vertical direction into the gas stream. Typically, the particle inlet is positioned to deliver the particle stream in a substantially downward direction into the gas stream. More typically, the particle inlet is positioned to deliver the particle stream into the acceleration gas stream.

The particle stream may be introduced into the acceleration gas stream at an angle formed between the particle stream and the horizontal component of the acceleration gas stream that is greater than 20 degrees, typically ranging from 60 to 90 degrees, and more typically ranging from 85 to 90 degrees.

The gas-particle processor may be configured to enable bi-directional flow of either or both particle and gas streams. Suitably, the gas-particle processor is configured to enable bi-directional flow of the gas stream.

The gas-particle processor may be configured to enable bi-directional cross-flow of the particle and gas streams. This enables contact of a particle curtain with a gas stream from multiple sequential directions.

In one example, a first horizontal gas stream is directed in a first direction that is in cross-flow with the particle curtain and subsequently directed in a second direction opposite to the first direction to change the direction of the particle curtain.

In this example, the bi-directional cross-flow system includes a cross-flow zone where the first horizontal gas stream contacts the particle curtain in the first direction.

The position of the separator within the cross-flow zone may be adjustable. Suitably, the height and length of the separator is adjustable.

The position of a separator between the cross-flow zones may be adjustable. Suitably, the height and length of the separator is adjustable.

In this example, each gas stream is separated into an acceleration gas stream and a main gas stream. Suitably, the gas stream is directed towards a separator to divide the gas stream into an acceleration gas stream and a main gas stream. The separator may maintain the different velocities of the acceleration gas stream and the main gas stream along the length of the chamber.

The number of gas streams may dictate the number of curtains formed in the chamber.

The acceleration gas stream may be located above the main gas stream.

The acceleration gas stream may form above the separator. The term “above” is understood herein to include that the acceleration gas stream flows at a height in the chamber that is greater than the height of the separator.

The main gas stream may form below the separator. The term “below” is understood herein to include that the main gas stream flows at a height in the chamber that is less than the height of the separator.

In one embodiment, the gas-particle processor comprises a horizontally arranged chamber. In this embodiment, the gas stream flows along the length of the chamber, the width of the particle curtain is defined by the width of the chamber and the distance that the particle falls is defined by the height of the chamber.

In a multi-stage operation involving multiple particle curtains being formed in a gas-particle contactor, a separator may be located before each particle inlet. This enables the gas approaching each particle inlet to separate into an acceleration gas stream and a main gas stream. It also enables particles introduced into the contactor via each particle inlet to contact the acceleration gas stream first.

The gas-particle processor may be configured to improve average slip velocity. The slip velocity is the magnitude of relative velocity components of the gas to the particles which are flowing in contact with each other. The slip velocity may be defined by the following equation, where the x, y, and z terms refer to the horizontal dimension (e.g. length), vertical dimension (e.g. height), and width dimension of the chamber:

$${U}_{slip} = \sqrt{{( {U}_{p , x} - {U}_{g , x} )}^{2} + {( {U}_{p , y} - {U}_{g , y} )}^{2} + {( {U}_{p , z} - {U}_{g , z} )}^{2}}$$

The gas-particle processor may be configured to achieve an average slip velocity of at least 10% higher, typically up to 15% higher, more typically up to 26% higher compared to a gas-particle processor without a separator.

The gas-particle processor may be configured to achieve straightness of a gas flow after a first curtain. The straightness of the gas flow is measured by a useful height factor defined by the equation:

$$Useful height factor = height of 90 \% of the main gas stream in the processing region / height of the processing region .$$

The straightness of gas flow is measured for the streamline gas flow of the main gas stream which flows in a direction along the length of the processor.

The useful height factor is the factor of the height at which 90% of the main gas stream exists in the processing region.

Suitably, the useful height factor has a value greater than 0.50. More suitably, the useful height factor ranges from 0.50 to 0.90.

The gas-particle processor may be configured such that less than 10 wt % of the particle stream, typically less than 7 wt %, more typically less than 5 wt % contacts the separator.

One focus of the applicant is to develop a gas-particle processor that optimises heat and/or mass transfer between the gas and particle streams in the processor, and it was determined that the residence time of the particle stream in the gas-particle processor is an important factor influencing the heat and/or mass transfer.

The heat and/or mass transfer effectiveness of the gas-particle processor along with the average residence time of the particles in the gas-particle processor in any given situation may be governed by a number of factors including one or more of the following factors:
slip velocity
particle volumetric velocity,
velocity ratio,
percentage separator protrusion, and
particle type.

For instance, minimising the volumetric velocity of the falling particle curtain may increase the residence time and/or the total available surface area of the particles in the chamber and therefore increase the heat and/or mass transfer effectiveness.

The heat transfer effectiveness is measured as a ratio of the actual heat transfer between the gas stream and the particle stream to the maximum theoretical heat transfer between the gas stream and the particle stream. The mass transfer effectiveness is measured as a ratio of the actual mass transfer of chemical species between the gas stream and the particles stream to the maximum theoretical mass transfer of chemical species.

The gas-particle processor may be configured to achieve an average residence time ranging from 0.1 to 10 seconds for one pass of the particle stream.

The average residence time may be achieved by controlling the percentage of separator protrusion in the chamber. The separator protrusion is defined by the equation:

$$Separator protrusion ( \% ) = \frac{\begin{matrix}Length of separator projecting \\ from an upstream edge of a particle inlet\end{matrix}}{Feeder length} \times 100$$

The average residence time may be controlled by designing the gas-particle processor to have a desired clearance angle.

It is desirable to minimise the variation of the particle residence time to optimise control of the contact between the particle and gas streams. This enables particle-related parameters such as particle temperature and particle dryness can be more precisely controlled. The variation of the particle residence time can be measured using a dimensionless variance of residence time.

The dimensionless variance of residence time of the particles may be defined by either equation below:

$$Dimensionless variance = {σ}_{θ}^{2} = \frac{{σ}^{2}}{{t}_{r}^{2}} \qquad ( i )$$

$$\% Standard deviation of residence time = \frac{σ}{{t}_{r}} \times 100 \% = \sqrt{{σ}_{θ}^{2}} \times 100 \% , \qquad ( ii )$$

wherein ø is standard deviation and tᵣ is average/mean residence time.

The curtain of the particle stream may have an at least 5% reduction in the dimensionless variance of residence time of the particles, typically at least 10% reduction in the dimensionless variance of residence time of the particles, more typically at least 15% reduction in the dimensionless variance of residence time of the particles, even more typically at least 20% reduction in the dimensionless variance of residence time of the particles, compared to a curtain of the particle stream formed in a gas-particle processor without a separator.

The curtain of the particle stream may have a dimensionless variance of residence time that is less than 0.00078, typically less than 0.00070, more typically less than 0.00067, even more typically less than 0.00065 for spoutable particles as defined by the Geldart particle classification. Typically, spoutable particles have an average diameter of at least 1 mm and a particle density at least 1,000 kg/m³.

The applicant realised that the percentage protrusion (relating to clearance angle) of the separator is a factor which affects one or more of the residence time, the useful height factor (straightness of gas flow), and the maximum horizontal flight of the acceleration air.

A higher percentage protrusion of the separator means that the separator is extending at least partially across the length of the particle inlet or feeder. This increases the total surface of the curtain by increasing the trajectory of the curtain across the processor.

The gas flow straightness can be measured by a useful height factor of the particle curtain. Improved flow straightness can be achieved by allowing the acceleration air to flow as horizontal as possible using a separator with a high percentage protrusion. The higher percentage protrusion can mitigate the effect of the acceleration air falling vertically upstream of the curtain. C The gas-particle processor may be configured to have a volumetric velocity ranging from, 1 to 50 L/s/m², suitably 1 to 10 L/s/m². The volumetric velocity is defined as the volumetric flow of particles passing through the particle feeder divided by the footprint area of the feeder.

The volumetric velocity may be defined by the following equation where mₛ is a mass flowrate of the particle stream, ρₛ is a particle density of the particle stream, f₁ is a length of the particle feeder, A_{feed} is an area of the particle feeder, Vₛ is a volumetric flowrate of the particle stream, and W is a width of the chamber:

$$Volumetric velocity ( \frac{m}{s} ) = \frac{\frac{{m}_{s}}{{ρ}_{s}}}{{A}_{feed}} = \frac{{V}_{s}}{{f}_{l} W}$$

At least 50% of the particles in the curtain may have a porosity defined by the volumetric velocity. Suitably, at least 60% of the particles in the curtain have a porosity defined by the volumetric velocity. More suitably, at least 80% of the particles in the curtain have a porosity defined by the volumetric velocity. Even more suitably, at least 90% of the particles in the curtain have a porosity defined by the volumetric velocity.

The chamber may comprise a processing region having a height measured from a bottom of the processor to the separator.

The chamber may have a length that exceeds its height. Suitably, the chamber is a horizontal duct. More suitably, the horizontal duct has a rectangular cross section.

The chamber may comprise a plurality of modular components. Suitably, each module includes one particle inlet. More suitably, each module includes one particle outlet. This allows the gas-particle processor to be expanded or reduced depending on need by connecting or disconnecting the necessary number of modules.

The applicant has realised that a bi-directional cross-flow modular system may increase the compactness of the gas-particle processor, particularly for taller contacting ducts.

The bi-directional cross-flow modular system may include a single duct with a plurality of separators arranged on both ends of the duct. Suitably, the particles are introduced from the top of the duct and exit from the bottom of the duct. More suitably, the particles are introduced into the duct from an inlet located at a top wall of the duct and the particles exit the duct from an outlet located at a bottom wall of the duct. The bi-directional cross-flow modular system may include multi-stage operation with multiple curtains.

The bi-directional cross-flow modular system may include using different gases for each cross-flow gas stream.

The bi-directional cross-flow modular system may include a permeable wall, or a honeycomb or a mesh to separate the gas streams. This prevents or minimises the interaction between the gas streams.

The gas-particle processor may be configured to coat at least part of the particles of the particle stream with a coating. The coating may be in the form of a liquid and/or a powder.

Suitably, the gas-particle processer may include a particle coater to coat the particles with the coating. The particle coating device may be integrated with the feeder arrangement of the processor. Suitably, the particle coating device may be a sprayer.

In some embodiments, the particles may be coated with the coating before entering the chamber. The coated particles can then be dried by the gas stream or react with the gas stream.

The particle feeder may be configured to introduce a particle stream in a substantially vertical direction into the gas stream. Typically, the particle feeder is configured to deliver particles downwardly into the gas stream.

The particle feeder may be configured to deliver particles into the chamber to optimise uniformity of the curtain(s) formed in the chamber. Typically, the particle feeder is configured to deliver particles into the chamber at a predetermined porosity.

The gas-particle processor may be configured to form a curtain of particles wherein at least 50% of the curtain has a porosity of at least 0.995. The particle feeder may be configured to deliver particles into the chamber to form a curtain of particles wherein at least 50% of the curtain has a porosity of at least 0.995.

The particle feeder may include a cassette which is configured to accommodate one or more properties of the particles, for example shape, size, surface morphology, to optimise uniformity of the curtain(s) formed in the chamber. Typically, the cassette comprises a mesh that allows particles to fall through and minimise agglomeration or aggregation of the particles. More typically, the cassette is removable and interchangeable depending on the properties of the particles.

The particle feeder may be configured to control the flow rate of particles delivered into the chamber. Typically, the particle feeder includes one or more plates that are arranged to have a predetermined spacing between each other to achieve a desired flow rate.

The number of plates may be selected to improve distribution of the particles delivered into the chamber.

The particle feeder may be in fluid communication with one or more particle inlets to deliver particles into the chamber. Suitably, the particle feeder is connected to one or more particle inlets to deliver particles into the chamber.

The particle feeder may be configured to control either or both the volumetric flowrate and mass flowrate of the particles delivered to the particle inlet. Suitably, the particle feeder is connected to a conveyor or a compressor to deliver the particles to the particle inlet at a predetermined velocity.

The particle feeder or the particle inlet may include a mesh. The mesh may improve distribution of the particles fed into the chamber and reduce agglomeration or clumping of the particles.

The particle feeder may have a length of at least 0.05 m, typically ranging from 0.05 to 1 m.

The gas-particle processor may include a pressure drive device downstream of the particle feeder to pull the acceleration gas through the top of the chamber and provide a pressure gradient to mitigate the induced vertical flow of the gas in the direction of the falling particles of the curtain. The pressure drive device may be a fan, blower, injector, eductor or a flow straightener. In one embodiment, the pressure drive device is a barrel fan.

The downstream fan may be configured to allow the gas horizontal passage through first the leading edge then the trailing edge. The trailing edge of the curtain, typically comprises fine/smaller particles compared to the leading edge of the curtain which typically comprises coarser/larger particles which are usually heavier. This ensures that the fan is effective in increasing the velocity of the acceleration gas and mitigating against induced downward gas flow.

Increasing the acceleration gas flow may counteract the downward momentum transfer of the particles. Doing so allows the gas flow profile to be as horizontal as possible relative to the general downward direction of the particles. Furthermore, by allowing the acceleration gas profile to be maintained as horizontal as possible, it mitigates the acceleration gas' ability to push down on the main gas stream, which would reduce the horizontal nature of the main gas. It may also mitigate vortex formation.

The present invention also provides a method of contacting a particle stream with a gas stream in a chamber, including:
(i) introducing a gas stream into the chamber, at least part of the gas stream forming an acceleration gas stream and a main gas stream in the chamber, wherein the acceleration gas stream has a higher average velocity than the main gas stream; and
(ii) introducing the particle stream into the gas stream and forming a curtain of the particle stream having an upstream edge and a downstream edge.

Suitably, the method involves contacting a particle stream with a gas stream using the previously mentioned gas-particle processor.

The term “contacting” is understood herein to include drying of or reacting of the particles using a gas stream.

The method may include introducing the gas stream in a substantially horizontal direction into the chamber.

The method may include directing the gas stream towards a channel bounded at its lower edge by a separator such that the acceleration gas stream forms above the separator.

The method may include directing the gas stream towards a channel bounded at its lower edge by a separator to maintain the different velocities of the acceleration gas stream and the main gas stream.

The method may include controlling the main gas stream and the acceleration gas stream at a velocity ratio ranging from 1 to 10, suitably, 1 to 6, and more suitably, 1 to 3.

The velocity ratio is defined as the ratio of the velocity of the acceleration gas stream to the velocity of the main gas stream. The method may include directing multiple gas streams into the chamber. Suitably, the method includes directing multiple gas streams in opposing directions into the chamber. More suitably, the method includes controlling the direction of the gas streams such that the direction of the gas streams alternates along the height of chamber.

The method may include directing the multiple gas streams towards a respective separator. This would form multiple pairs of acceleration gas and main gas streams.

The method may include controlling one or more of gas stream velocity, particle stream velocity, position and size of separator and chamber dimension such that the curtain of the particle stream has an at least 5% reduction in the dimensionless variance of residence time of the particles compared to a curtain of the particle stream formed in a gas-particle processor without a separator.

The method may include introducing particle stream in a substantially vertical direction into the gas stream. The method may include introducing the particle stream into the acceleration gas stream. Typically, the method includes introducing the particle stream in cross-flow with the acceleration gas stream. It is believed that maintaining a horizontal acceleration gas stream maximises the total surface area of the curtain exposed to the gas stream.

The method may include controlling the main gas stream and the acceleration gas stream velocities to improve the momentum transfer of the gas stream to the particle stream.

The method may include introducing the particle stream into the gas stream at an angle between the particle stream and a horizontal component of the gas stream that is greater than 20 degrees, typically ranging from 60 to 90 degrees, and more typically ranging from 85 to 90 degrees.

The method may include maintaining atmospheric pressure in the chamber.

The method may include maintaining a pressure in the chamber that is equal to a pressure of a source of the particle stream.

The method may include introducing a positive pressure in the acceleration gas stream and increasing the velocity of the acceleration gas stream.

The method may include using a pressure drive device downstream of an inlet of the particle stream to pull the acceleration air through the top of the chamber. The pressure drive device may be a fan, blower, injector, eductor or a flow straightener.

The method may include maintaining a curtain of particles wherein at least 50% of the curtain has a porosity of at least 0.995. The porosity may be maintained by controlling a volumetric velocity of the curtain ranging from 1 to 50 L/s/m². This allows a substantial proportion of the particles within the particle stream to be unhindered by adjacent particles in the particle stream.

The volumetric velocity is defined by the following equation where mₛ is a mass flowrate of the particle stream, ρₛ is a particle density of the particle stream, f₁ is a length of the particle feeder, A_{feed} is an area of the particle feeder, Vₛ is a volumetric flowrate of the particle stream, and W is a width of the chamber:

$$Volumetric velocity ( \frac{m}{s} ) = \frac{\frac{{m}_{s}}{{ρ}_{s}}}{{A}_{feed}} = \frac{{V}_{s}}{{f}_{l} W}$$

The method may include coating at least part of the particles of the particle stream with a coating.

The coating may be in the form of a liquid and/or a powder.

The method may include using a particle coating device to coat the particles with the coating.

The particle coating device may be a sprayer.

The method may include coating the particles with the coating before entering the chamber.

The method may include forming a processing region having a height measured from a bottom the chamber to the separator which is equivalent to the height of the separator.

The method may include achieving straightness of a gas flow after a first curtain. The straightness of the gas flow may be measured by a useful height factor defined by the equation:

$$Useful height factor = height of 90 \% of the main gas stream in the processing region / height of the processing region .$$

The useful height factor may have a value greater than 0.50, and suitably, 0.5 to 0.9. The method may include controlling one or more of gas stream velocity, particle stream velocity, position and size of separator and chamber dimension such that less than 10 wt % of the particle stream contacts the separator.

The method may include achieving an average residence time ranging from 0.1 to 10 seconds.

The average residence time may be achieved by controlling a percentage separator protrusion and any one or more of the particle volumetric velocity, the velocity ratio, and particle type. The percentage separator protrusion may be up to 100%, and typically ranges from 25% to less than 100%.

The particle size of the particles may range from 50 to 10,000 microns. The applicant observed that particles with size less than 50 microns may experience problems with the cohesiveness of the particles. For these particles, the increased surface area per kg of particles compared to larger particles (e.g. larger than 10,000 microns) may drastically inhibit flow straightness of the main gas stream after the curtain in a multi-stage system. This is because larger particles are too heavy and may fall too fast through the main gas stream for effective cross-flow to occur. The cross-sectional height to width ratio of the chamber may be greater than or equal to 1. The residence time of the falling particles may be increased by maximising the falling height of the particles across the cross-sectional area of the chamber. The cross-section height to width ratio may be less than 1 to increase the width of the chamber and the amount of feed introduced into the chamber while increasing residence times using other parameters such as any one or more of the volumetric velocity, the velocity ratio, the percentage separator protrusion, and particle type.

### BRIEF DESCRIPTION OF THE DRAWINGS

The present invention is described further by way of example only with reference to the accompanying drawings, wherein:

FIG. 1 is a schematic diagram of an embodiment of the gas-particle processor of the invention at a first curtain condition.

FIG. 2 is a schematic diagram of an embodiment of the gas-particle processor of the invention at a second curtain condition.

FIG. 3 is a schematic diagram of an embodiment of the gas-particle processor of the invention that includes two curtains.

FIG. 4 is a schematic diagram of an embodiment of a gas-particle processor of the invention that includes a film coating drying process.

FIG. 5 is a schematic diagram of an embodiment of the gas-particle processor of the invention that includes a film coating drying process for a multi-stage system.

FIG. 6 is a schematic diagram of an embodiment of the gas-particle processor of the invention that includes a film coating drying process for a continuous multi-stage system.

FIG. 7 is a schematic diagram of an embodiment of the gas-particle processor of the invention that includes a film coating drying process for a continuous multi-stage system in a single duct.

FIG. 8 is a schematic diagram of an embodiment of the gas-particle processor of the invention that includes multiple fans to maintain the volumetric flow of the acceleration air.

FIG. 9 is a perspective view of a cassette of a particle feeder of the invention.

FIG. 10 is a cross-sectional view of a particle feeder of the invention including the cassette of FIG. 9.

FIG. 11 is a schematic diagram of an embodiment of the gas-particle processor and pilot plant of the invention.

FIG. 12 is a CFD modelling diagram for a gas-particle processor without a separator.

FIG. 13 is a CFD modelling diagram for a gas-particle processor with 50 mm acceleration air height and 0% separator protrusion.

FIG. 14 is a CFD modelling diagram for a gas-particle processor with 75 mm acceleration air height and 0% separator protrusion.

FIG. 15 is a CFD modelling diagram for a gas-particle processor with 75 mm acceleration air height and 60% separator protrusion.

FIG. 16 is a CFD modelling diagram for a gas-particle processor with 75 mm acceleration air height and 100% separator protrusion.

FIG. 17 is a CFD modelling diagram for a gas-particle processor with 100 mm acceleration air height and 0% separator protrusion.

FIG. 18 is a CFD modelling diagram for a gas-particle processor with 100 mm acceleration air height and 20% separator protrusion.

FIG. 19 is a CFD modelling diagram for a gas-particle processor with 100 mm acceleration air height and 60% separator protrusion.

FIG. 20 is a CFD modelling diagram for a gas-particle processor with 100 mm acceleration air height and 100% separator protrusion.

FIG. 21 is a CFD modelling diagram for a gas-particle processor with 200 mm acceleration air height and 0% separator protrusion.

FIG. 22 is a CFD modelling diagram for a gas-particle processor with 200 mm acceleration air height and 60% separator protrusion.

FIG. 23 is a CFD modelling diagram for a gas-particle processor with 200 mm acceleration air height and 80% separator protrusion.

FIG. 24 is a graph of heat duty vs percentage separator protrusion for different acceleration air heights during experimental CFD simulation work.

FIG. 25 is a graph of average residence time vs percentage separator protrusion for different acceleration air heights during experimental CFD simulation work.

FIG. 26 is a graph of horizontal flight vs percentage separator protrusion for different acceleration air heights during experimental CFD simulation work.

FIG. 27 is a graph of useful height of curtain (flow straightness) vs percentage separator protrusion for different acceleration air heights during experimental CFD simulation work.

FIG. 28 is a graph of standard deviation residence time vs percentage separator protrusion for different acceleration air heights during experimental CFD simulation work.

FIG. 29 is a schematic diagram of an embodiment of the gas-particle processor of the invention including a bi-directional cross-flow modular unit for a single particle curtain.

FIG. 30 is a schematic diagram of an embodiment of the gas-particle processor of the invention including a bi-directional cross-flow modular unit for a single particle curtain with a permeable wall.

FIG. 31 is a schematic diagram of the experimental setup of the bi-directional cross-flow system during experimental CFD simulation work.

FIG. 32 is a CFD modelling diagram for Design 1 of the simulation during Experiment 2.

FIG. 33 is a CFD modelling diagram for Design 2 of the simulation during Experiment 2.

FIG. 34 is a CFD modelling diagram for Design 3 of the simulation during Experiment 2.

FIG. 35 is a schematic diagram of the clearance angle between the separator and the particle inlet in the gas-particle processor of the invention.

FIG. 36 comprises graphs illustrating the relationship between slip velocity and heat and mass transfer coefficients for Persian clover seeds contacted by air.

FIG. 37: Graphs illustrating the slip velocity distributions for single curtain with and without separators.

FIG. 38 is a CFD modelling diagram generated during Experiment 3 for a single curtain embodiment of the invention with no separator.

FIG. 39 is a CFD modelling diagram generated during Experiment 3 for a single curtain embodiment of the invention with separators.

FIG. 40 is a CFD modelling diagram generated during Experiment 3 for a single curtain embodiment of the invention with separators and a pressure drive device.

FIG. 41 is a CFD modelling diagram generated during Experiment 4 for a multi-curtain embodiment of the invention with no separators and pressure drive.

FIG. 42 is a graph illustrating the slip velocity distribution of curtain 1 without separators.

FIG. 43 is a graph illustrating slip velocity distribution of curtain 2 without separators.

FIG. 44 is a CFD modelling diagram for a 2-curtain system with particle and gas streamlines according to Design 1 of Experiment 4.

FIG. 45 is a graph illustrating slip velocity distribution of curtain 1 according to Design 1 of Experiment 4.

FIG. 46 is a graph illustrating slip velocity distribution of curtain 2 according to Design 1 of Experiment 4.

FIG. 47 is a CFD modelling diagram for a 2-curtain system with particle and gas streamlines according to Design 2 of Experiment 4.

FIG. 48 is a graph illustrating slip velocity distribution of curtain 1 according to Design 2 of Experiment 4.

FIG. 49 is a graph illustrating slip velocity distribution of curtain 2 according to Design 2 of Experiment 4.

FIG. 50 is a schematic diagram illustrating the leading and trailing edges of a particle curtain.

### DETAILED DESCRIPTION

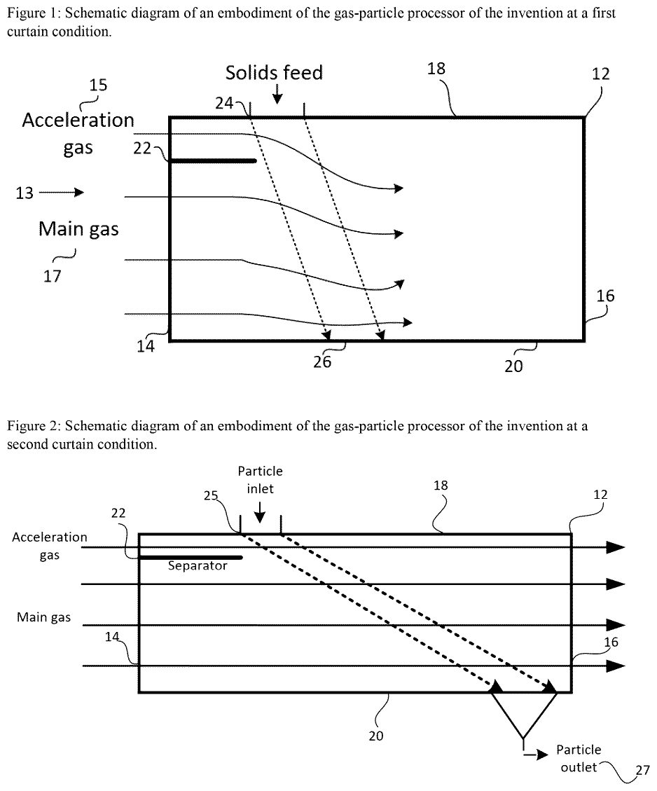

One form of a gas-particle processor is illustrated in FIGS. 1 and 2. The processor 10 comprises a chamber 12 having a first end 14, an opposite second end 16 and top and bottom walls 18, 20, top and bottom walls 18, 20 extending between the first and second ends. The second end is located on an opposing side of the first end and the side wall portions extend generally horizontally so as to define a horizontally orientated chamber. A separator in the form of tongue 22 extends from the first end 14 of the chamber.

The chamber 12 has an array of particle inlets 24 through which particles are introduced into the chamber. Solid particles can be fed to each inlet by any type of particle feeder. The feeder may be configured to introduce the particles into the chamber so that they fall under gravitational acceleration or are accelerated into the chamber. The inlets or feeders may include a screen, a sieve, grate, grid or the like through which the particles are introduced into the chamber. Suitably, the screen, a sieve, grate or grid is deployed in embodiments which introduce the particles into the chamber via free fall (i.e. by force of gravity). The purpose of the screen, a sieve, grate or grid is to reduce agglomeration or clumping of particles and evenly distribute the particle flow across the feeder or particle inlet before they are introduced into the chamber and to set the mass flow rate of the particles.

The particle inlets 24 are located on the top wall 18 of the chamber. The outlets of the feeders communicate with and/or are co-existent with the particle inlets 24. The processor is configured and operated such that the particles fed through each particle inlet produces separate and discrete streams of particles which flows from the top wall to a bottom wall portion.

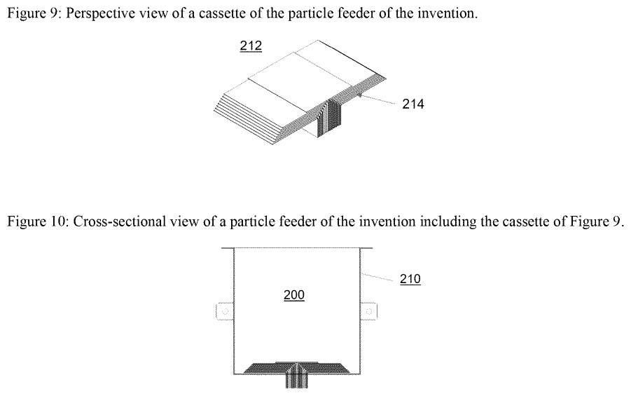

FIG. 10 illustrates an embodiment of a particle feeder 200 including a housing 210 with particle inlet 24. A cassette 212 (see FIG. 9) is positioned at the particle inlet 24.

Cassette 212 comprises a plurality of right angled plates 214 that are spaced according to the desired flow rate of particles at their relevant particle size and distribution. The number of plates is configured to create an even distribution of particles falling under gravity, with the total spacing at the particle inlet 24 creating the horizontal dimension of the curtain of particles.

The spacings between the plates are believed to provide the largest resistance of the particles as the particles slide along towards the right-angled bend before falling vertically, with lateral vibration of the particle feeder housing 210 (with particles above and around it) allowing the particles to pass through the spacings horizontally and then falling vertically. Therefore, the flow rate for a particular particle size and distribution is controlled by the spacings of the plates relative to the particle size and shape and the feeder housing 210 vibration (frequency and amplitude). The right-angled plates 214 are designed to prevent funneling of the particle flow towards the centre of the horizontal dimension by creating different horizontal distances for the particles to travel and therefore creating an even distribution of the vertically flowing particles.

The chamber 12 also has an array of particle outlets 26 through which particles exit the chamber. The particle outlets are formed on the opposing bottom wall 20 to that which the inlets are located. The particle outlets 26 oppose, but are offset from, respective particle inlets 24. Each outlet is located downstream from its respective inlet due to some horizontal travel of the particles as they move through the chamber. The discrete particle streams flowing from respective particle inlets 24 exit the chamber through a specific particle outlet. For example, particles flowing from the first particle inlet 24 exit the chamber through the first particle outlet 26 only.

At a first particle curtain condition as illustrated in FIG. 1, the particle outlet 26 is located on the opposing bottom wall 20 to which the particle inlet 24 is located. At a second curtain condition as illustrated in FIG. 2, a particle inlet 25 is located on the top wall 18 of the chamber 12. Particles are introduced into the chamber through the particle inlet 25 and are induced to flow substantially horizontally rather than vertically as compared to FIG. 1.

As the particles fall through the gas in the processor 10, heat and/or mass exchange and/or a chemical reaction occurs between the particle stream and the gas stream. At any moment in time within the chamber 12, the particle streams in the chamber do not substantially intermix.

Because of the ability of the processor to operate with a number of discrete particle streams, it can act as a “multi-stage” processor. A multi-stage processor can be configured to receive two or more fresh feeds. The multi-stage processor may include a plurality of particle inlets and outlets in which each particle inlet is paired with a dedicated outlet. This provides the benefit of reducing the space and cost requirements over having multiple processors to carry out the same number of single particle stream processes.

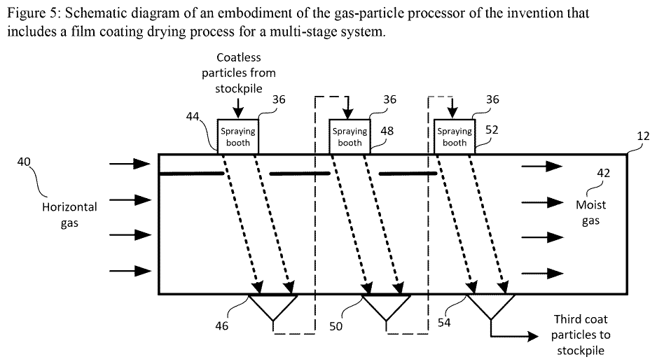

The arrays of particle inlets and outlets could be configured to recycle particles through the chamber 12. In one form, this recycling could be from each outlet to its respective inlet. In another embodiment, the first particle outlet 46 is connected to the second particle inlet 48 via conduit and the second particle outlet 50 is connected to the third particle inlet 52 via another conduit so that particles flow between the connected outlets and inlets. One form of this embodiment is illustrated in FIG. 5. In this embodiment, the first particle inlet 44 defines an initial feed of particles to the chamber 12 and the third particle outlet 54 defines a final outlet for particles to exit the chamber 12 and leave the processor. In a variation, the system may be semi-closed so that some of the particles leave the processor at the third particle outlet but some are recycled to the first particle inlet with a make-up of particles added to compensate for the particles that have exited the system.

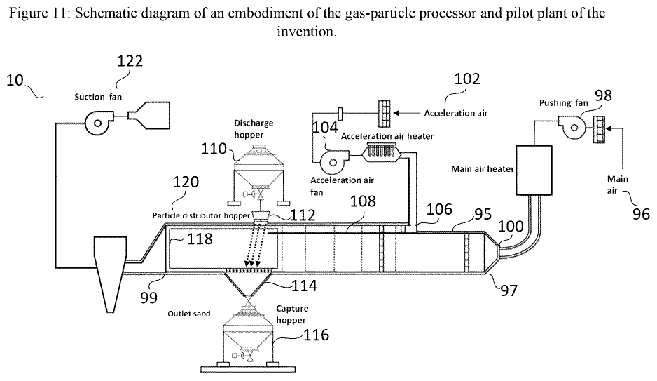

The chamber 95 as illustrated in FIG. 11 also comprises a main gas inlet 100 located at the first end 97 and a gas outlet 118 located at the second end 99 of the chamber 95 whereby gas flows along the length of the chamber between the inlet and the outlet during operation of the processor 10. To provide and direct this flow of gas, the processor 10 may include a main gas feeder 98 which feeds gas to the main gas inlet 100 of the chamber. The gas feeder is in the form of a pump, compressor, blower or the like. The chamber also comprises an acceleration gas inlet 106. The processor may include an acceleration gas feeder 104 which may be in the form of a fan to provide the acceleration gas 102. The acceleration gas and the main gas streams are separated within the chamber 95 by a tongue 108. The solid particles are discharged from a hopper 110 into a particle inlet 112 of the chamber. The respective particle outlet 114 of the chamber is connected to a hopper 116 to capture the exiting particle stream. The main gas stream exits the chamber at the gas outlet 118. The processor may include an additional hopper 120 downstream of the chamber to collect any residual particles in the exiting gas and a suction fan 122 to direct the gas flow.

It is understood that the processor may comprise more or less particle inlets and outlets. In one variation, the processor may comprise a single particle outlet formed at the bottom of the chamber which receives all the particles entering the chamber through the inlets.

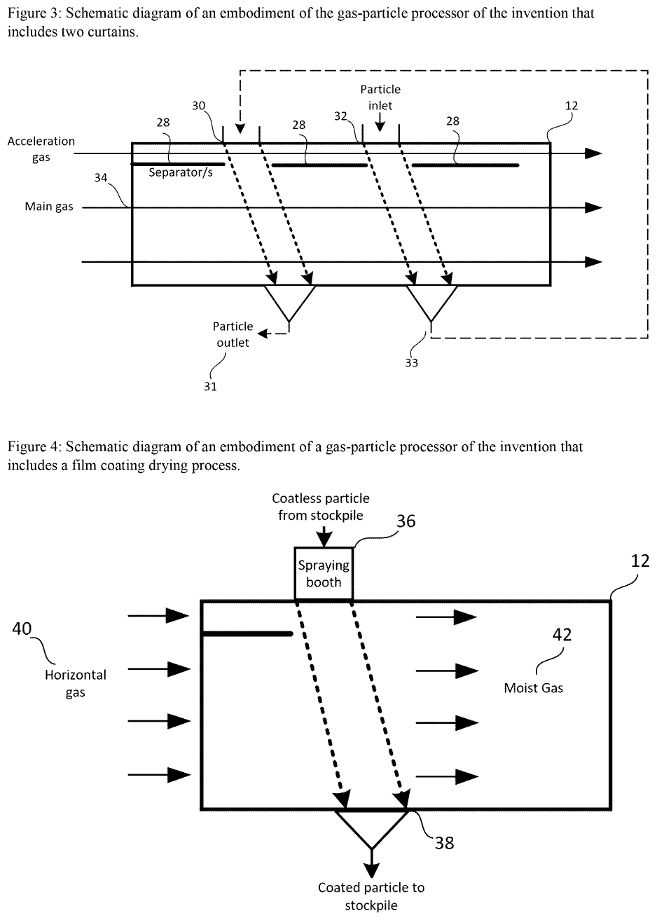

Another form of the gas-particle processor is illustrated in FIG. 3 in which a plurality of tongues 28 are located in the chamber and are located upstream and downstream to the particle inlets 30 and 32. Gas can be introduced into the chamber as a single stream using one gas inlet which is then divided into the acceleration gas and main gas streams using the separator or separate acceleration gas and main gas streams can be introduced into the chamber using dedicated gas inlets.

One benefit of having an acceleration gas stream with a higher velocity than a main gas streams is that heat and/or mass transfer may be optimised by maximising slip velocity. This can be achieved by controlling the acceleration and main gas stream profiles to be as horizontal as possible as seen by the following equation, with the Yₛₗᵢₚ term providing the most significant contribution to slip velocity:

$${U}_{slip} = \sqrt{{( {U}_{p , x} - {U}_{g , x} )}^{2} + {( {U}_{p , y} - {U}_{g , y} )}^{2} + {( {U}_{p , z} - {U}_{g , z} )}^{2}}$$

x is horizontal dimension (e.g. length) of the chamber, y is vertical dimension (e.g. height) of the chamber, and Z is width dimension of the chamber.
Xₛₗᵢₚ is maximised when the gas streamlines are perpendicular to the particle flow, i.e. when the x term for the particles is as close to 0 as possible while the gas x velocity is improved.
Yₛₗᵢₚ is maximised when the gas streamlines have a vertical downward velocity as close to 0 as possible while the particles fall under gravity.
Z term assumed to be negligible.

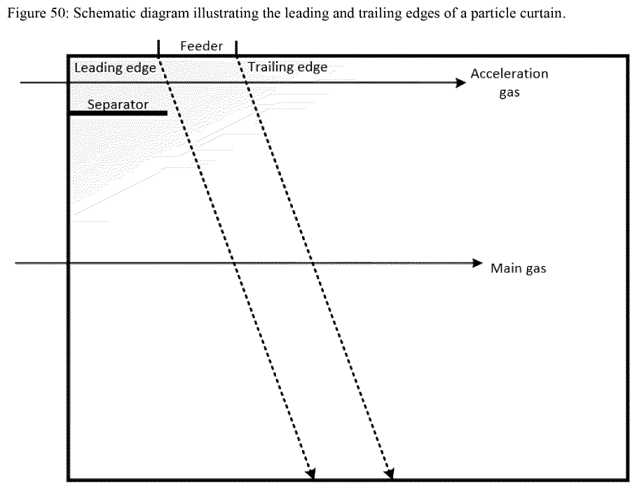

Two curtains are formed in the chamber of the processor. FIG. 50 illustrates the leading and trailing edges of a particle curtain. The particles in the first curtain exit the chamber at the particle outlet 31. The particles exiting the second curtain at particle outlet 33 can be recycled and reintroduced into the chamber and the first curtain at particle inlet 30. The presence of multiple tongues reduces the downward force on the main gas stream 34. This allows a larger portion of the main gas stream to maintain a useful height factor compared to for example FIG. 1. In another embodiment, a pressure gradient along the pathway of the acceleration gas stream may be maintained by inserting one or more fans, blowers, eductors, flow straighteners or other pressure drive devices adjacent to the multiple tongues.

Upstream and downstream tongues coupled with the use of the fans, blowers, flow straighteners or other pressure drive devices to increase the acceleration gas flow velocity help mitigate the downward drag imposed by the particles on the acceleration and main gas flow profiles.

The applicant discovered that it would not have been possible to re-accelerate the bulk gas flow velocity without the upstream and downstream tongues. The applicant has also run a simulation to show that in some scenarios about 50% less total gas flow is needed for a curtain with a tongue to land in the same location as without a tongue.

FIGS. 4-7 illustrate further forms of the gas-particle processor including a spraying booth 36 which coats the solid particles with a liquid layer before the particles are introduced into the chamber. Depending on the desired final form of the particles, the gas may be used to dry or react with the coated particles. In these Figures, moisture is removed from the particles into the gas stream to form a moist exiting gas stream.

FIG. 4 illustrates a cross-flow contacting arrangement for drying a wet film coating on a particle. This arrangement involves both heat and mass transfer as there is heating and evaporation of the coating and heating of the particles.

The particles are fed into the spraying booth 36, where nozzles spray liquid droplets onto each individual particle, creating an even film coat onto each particle. As the wet coated particles exit the spraying booth 36, they enter the chamber 12. A horizontal drying gas 40 is supplied to the chamber 12. The horizontal drying gas comprises an acceleration gas stream and a main gas stream. Each of these gas streams can be introduced separately into the chamber or formed in the chamber using separator 28. Firstly, the coated particles contact the acceleration gas which imparts horizontal acceleration to the particles. The particles then fall in the main gas stream where most of the drying occurs. The coating on each particle is dried such that the particles do not clump together or deform at the particle outlet 38. Different coatings will have different drying requirements to reach an acceptable dryness level in the coating. The film coating on each particle allows for rapid drying of the moisture in the coating in the time it takes for the particles to fall through the processor.

The residence time of each particle is important, as the drying kinetics of the coating dictate how long the wet coated particle must be in contact with the hot gas to dry to the extent necessary to avoid clumping or deformation. As a result of the mass transfer of the water from the coating to the horizontal drying gas, the drying gas will remove moisture from the coating. The relative humidity in the outlet gas (moist gas 42) changes according to the mass fraction of water in the outlet gas and the outlet temperature. Excess moisture in the outlet gas is removed downstream of the curtain. The excess moisture may be removed, recycled or integrated within the gas-particle process for heat recovery. The resultant dried gas may be recycled and used as the inlet gas stream for drying the first curtain, creating a closed loop.

FIG. 5 illustrates the embodiment of FIG. 4 optimised for a larger throughput of particles for the same flow of horizontal drying gas 40. In this embodiment, the particles can be dried into n number of successive layers within the same duct. In use, the particles enter a spraying booth 36 to coat the particles, they then enter the chamber 12 through a first particle inlet 44 to form a particle curtain. Water is evaporated from the coating of the particles in this curtain to a pre-determined level and the particles exit via first particle outlet 46. The particles are then directed to another spraying booth 36 for a second coating. The coated particles then enter the second particle inlet 48 to form a second particle curtain where the second coating is dried. The second particle curtain exits the chamber via the second particle outlet 50 and is directed to another spraying booth 36. The coating process is repeated to form a third coating on the particles before the particles re-enter the chamber via the third particle inlet 52. The particles are dried in the chamber to produce particles with three layers of coating which exit via particle outlet 54.

Advantageous effects of this arrangement include: i) better utilisation of the energy required to heat the gas to the temperature needed for drying (higher particle throughput per kWh consumed); ii) more compact design as this arrangement only requires one duct to dry multiple layers; iii) quality control on each layer ensures that each coating layer is dried before progressing to the next coating and drying stage; and iv) manipulability of the coat drying kinetics can lead to an optimised process for quality-controlled product vs energy consumption.

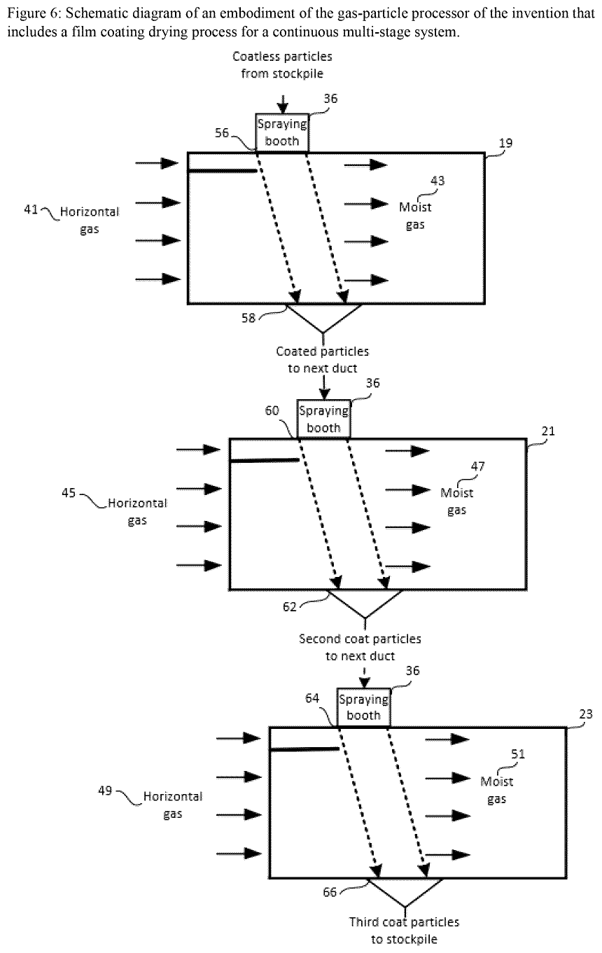

In another embodiment as illustrated in FIG. 6, the multi-stage system of FIG. 5 is operated as a continuous process where each coating stage is performed in a separate duct which coats and dries each layer of the coating. Similar to the embodiment of FIG. 5, the particle outlet of the previous stage becomes the particle inlet for the next coating stage. However, in this embodiment each duct is vertically stacked to allow gravity to accelerate the particles through the successive stages. A first stream of horizontal drying gas 41 is directed to a first duct 19. The horizontal drying gas 41 forms an acceleration gas stream and a main gas stream in the chamber, in which both streams are separated by the separator. The particles enter a spraying booth 36 and are coated with a layer before entering the chamber via a particle inlet 56. The gas stream removes water from the coating such that the exiting gas (moist gas stream 43) contains a mass fraction of the moisture from the coating. The coated particles exit the first duct through a particle outlet 58 and are directed into another spraying booth 36. The wet coated particles exiting the spraying booth then enter a second duct 21 through a particle inlet 60 and the second coating is dried using a horizontal drying gas stream 45. The particles with the dried second coat exit the duct through the particle outlet 62 and enter another spraying booth for a third coating. The wet coated particles enter a third duct 23 through a particle inlet 64 where the third layer of coating is dried using a horizontal drying gas 49. The dried particles exit the third duct through a particle outlet 66 to form a final product.

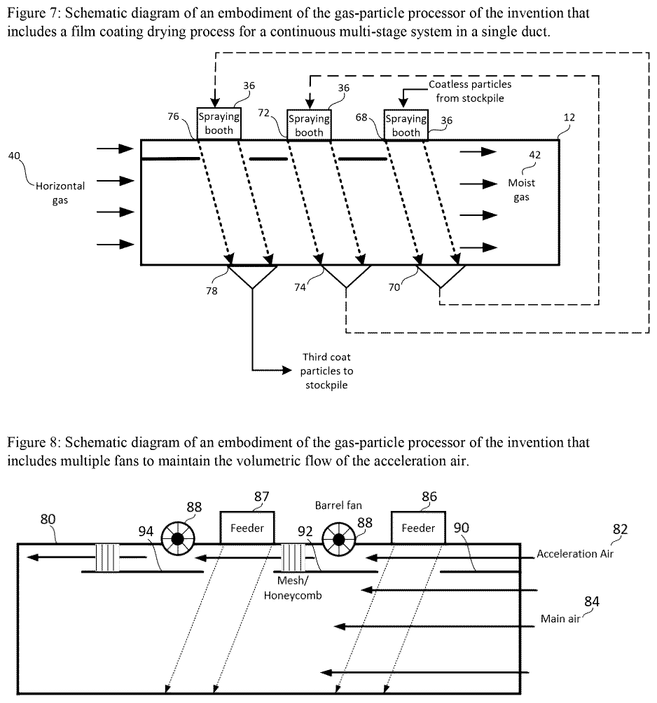

The advantageous effect of such an embodiment is that contamination is less likely as each coating exists in a different duct. On the other hand, such a system is less compact and requires a higher capital cost for the same throughput of particles (for example, higher capital cost of fans and energy consumption). An alternative multi-stage embodiment to the embodiment of FIG. 5 is illustrated in FIG. 7. Three successive coating and drying stages operate in a single chamber or duct as a continuous process. A horizontal drying gas flows through a chamber 12 with three particle inlets. As the gas moves horizontally across the chamber, it becomes colder and more moist. Solid particles are coated in a spraying booth 36 before entering the chamber through a particle inlet 68 that is farthest from the inlet of the horizontal drying gas. The coated particles interact with the coldest and highest moisture content gas and are dried. The particles from the first particle outlet 70 are directed to another spraying booth and coated. The coated particles enter the chamber at a second particle inlet 72 that is between the inlet of the horizontal drying gas stream and the first particle inlet 68. The coated particles are dried using the horizontal drying gas stream and exit the chamber at a particle outlet 74. The particles at the particle outlet 74 are directed to another spraying booth for a third coating. The coated particles enter the chamber at a third particle inlet 76 and interact with the horizontal drying gas stream when it is hottest and driest. The particles with the three coating layers are dried and exit at the third particle outlet 78 to produce the final product. This system is optimised for temperature and concentration driving forces. However, the system may be configured to control relative humidity which may prevent effective drying in the later curtains.

During operation, the gas flows through the chamber 12 at a streamline (first) velocity which is generally linear in the horizontal direction.

The gas stream 13 is directed towards tongue 22 such that the gas stream is divided into an acceleration gas stream 15 and a main gas stream 17, as illustrated in FIG. 1. The ratio of acceleration gas stream velocity to the main gas stream velocity ranges from 1-6. It is believed that a vortex is formed in the space above and inside the processing region of the processor. The processing region is defined as the region occupied by the main gas stream between the bottom of the processor and the tongue.

Each stream of particles is introduced into the chamber at a second velocity and a feed angle with respect to the direction of the streamline velocity of the gas.

The gas and each particle stream have respective first and second mass flowrates through the chamber. Preferably, during operation of the processor one or both of these mass flowrates are controlled to obtain the desired particle curtain properties such as straightness of the gas flow, porosity, effective surface area per unit volume of particles in a curtain and particle residence time.

The gas-particle processor may have multiple inlets for introducing multiple particle streams into the chamber and respective outlets. Each particle stream may have a different mass flowrate and/or different types of particles.

It is important that a substantial proportion of the particles with the particle stream is unhindered by adjacent particles in the particle stream. The resulting increased access to the particles' surface by the gas improves heat and/or mass transfer and/or chemical reaction, for example, to facilitate drying of particles in the particle stream.

Another embodiment of the present invention is illustrated in FIG. 8. A first tongue 90 is located within the chamber at the inlet of an acceleration air 82 and a main air 84 streams. A plurality of tongues 92, 94 are located downstream and in line with the first tongue 90. Multiple barrel fans 88 are located adjacent to the particle inlets 86 and 87.

In this embodiment, the fan 88 creates suction which pulls the acceleration air stream through the first curtain so that the acceleration air stream is directed horizontally to the downstream tongue 92. Instead of the acceleration air stream falling vertically as the particles interact with the main air stream, the ‘pulling’ of the acceleration air stream using the fan creates a well distributed particle curtain. This also conserves the acceleration air stream characteristics for the downstream curtain as the volumetric flow rate of the acceleration air stream can be maintained by the fan.

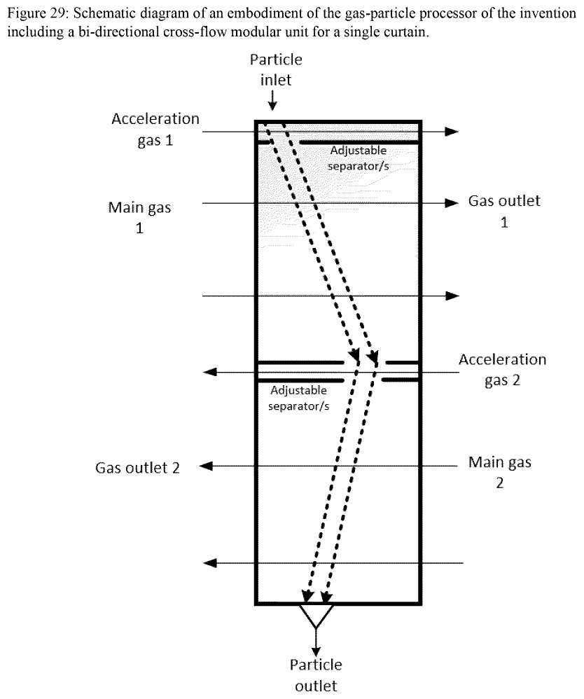

Another embodiment of the invention is illustrated in FIG. 29. The particles are introduced into the duct of the modular unit through a particle inlet located at a top wall of the duct. A first horizontal cross-flow gas stream is separated into an acceleration gas 1 and a main gas 1. The acceleration gas 1 enters the duct from an inlet located at a first end of the duct at a region above a first tongue or partition. The main gas 1 enters the duct from an inlet located at a first end of the duct at a region below the first partition. The particles are introduced into the acceleration gas stream 1 through the particle inlet. The particles then fall through a gap in the first partition and are introduced into the main gas 1 forming a particle curtain. The main gas 1 and acceleration gas 1 exit the duct from a gas outlet 1 located at a second end of the duct opposite to the first end of the duct.

A second horizontal cross-flow gas stream is introduced into the duct in an opposite direction from the first cross-flow stream from an inlet located at the second end of the duct. The second cross-flow gas stream is separated into an acceleration gas 2 and a main gas 2. The acceleration gas 2 enters the duct through a channel formed by a second partition and a third partition. The main gas 2 enters the duct at a region below the third partition. The curtain is introduced into the acceleration gas 2 through a gap in the second partition which changes the direction of the curtain in the opposite direction. The curtain is then introduced into the main gas 2 through a gap in the third partition. The particles of the curtain exit the duct from a particle outlet located at the bottom end of the duct. The main gas 2 and the acceleration gas 2 exit the duct from an outlet located at the first end of the duct. The partitions help protect the flow of each horizontal cross-flow gas stream from leaking into another adjacent gas stream. Pressure balancing is required to equalise gas pressure through the vertical path of the falling particles. The acceleration gas provides the momentum transfer to shift the flow of the particles in the opposite direction as particles move from the influence of one gas stream to another. The acceleration gas also keeps the overall gas flow horizontal (mitigates against induced vertical flow).

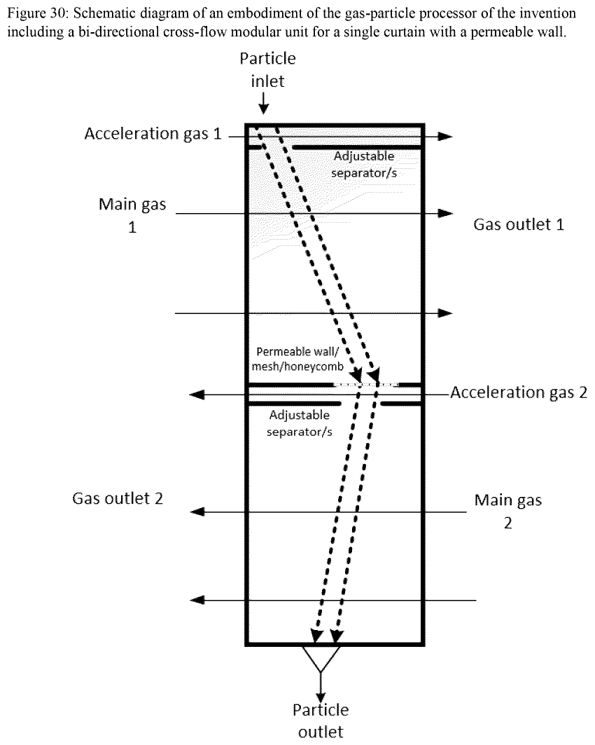

Another embodiment of the invention further to the embodiment of FIG. 29 is illustrated in FIG. 30. To further discourage the separate cross-flow gas streams from interacting with each other, a permeable wall or honeycomb or mesh may be used to cover the gaps between the partitions, allowing particles to pass through but limiting vertical gas turbulence that might encourage gas to pass through to another cross-flow gas stream below. This type of system is suitable for particles which do not coalesce and for particles that are not susceptible to mechanical stress.

FIG. 35 is a schematic diagram showing the clearance angle between the separator and the particle inlet and provides equations defining the clearance angle and percentage separator protrusion.

### Experimental Work

### Experiment 1

Experimental work in relation to the present invention was carried out by the applicant to demonstrate that the invention can achieve high surface area of the curtain and improve the straightness of the gas flow in the gas-particle processor.

The applicant conducted two phases of experimental work:
i) a physical experimental program on a pilot plant which generated the VIPAC accredited data set which formed a basis of the physically validated CFD model, and
ii) a virtual experimental program to test the impact of an acceleration air, a separator and protrusion of the separator.

Details of the physical experimental work are summarised below:
i. The experiments were conducted in a physical pilot plant set up of a horizontal contactor with acceleration gas, main gas and a separating partition.
i. The experiments involved a sensible heat transfer application involving a stream of hot air as the total gas stream and a stream of silica sand particles as the particle stream.
ii. The gas-particle processor operated as a horizontal duct with a height of 0.5 m and a width of 0.5 m. The acceleration gas height was 0.05 m
iii. The mass flow rate of the total gas stream, comprising an acceleration air flow and a main gas flow, was kept constant at ˜0.4 kg/s. The inlet temperature of the total gas was kept constant at 132° C.
iv. The mass flow rate of the particle stream was kept constant at ˜0.5 kg/s.
v. Each experiment was conducted over a steady state period of 40-45 minutes.
vi. The acceleration air height was defined as the height above the separator at which the acceleration air was supplied. In the experiments the acceleration air height was 0.05 m.
vii. Separator protrusion (%)=0 was kept constant.
viii. The experiments were conducted for three different velocity ratios.
ix. The heat duty and heat transfer effectiveness were measured for each experiment.
x. The experiment was conducted for gas-particle processors with one curtain only.
xi. Each experiment was then simulated using Computational Fluid Dynamics (CFD) modelling software. The CFD simulations were able to predict the experimental results to an acceptable level which validated the modelling work.

Details of the virtual experimental work is summarised below:
i. The experiment was conducted using Computational Fluid Dynamics (CFD) modelling software which was validated using the results from the physical experiment on the pilot plant.
ii. The CFD modelling software simulated a specified sensible heat transfer application involving a stream of hot air as the total gas stream and a stream of soda ash particles as the particle stream.
iii. The gas-particle processor was modelled as a horizontal duct with a height of 1.003 m and a width of 0.5 m.
iv. The mass flow rate of the total gas stream, comprising an acceleration air flow and a main air flow, was kept constant at 1.13 kg/s.
v. The mass flow rates of the acceleration air and the main air were kept constant.
vi. The mass flow rate of the particle stream was kept constant at 1 kg/s.
vii. The acceleration air height was defined as the height above the separator at which the acceleration air was supplied.
viii. The percentage of separator protrusion was calculated using the below equation:

$$Separator protrusion ( \% ) = \frac{\begin{matrix}Length of separator projecting \\ from an upstream edge of a particle inlet\end{matrix}}{Feeder length} \times 100$$

ix. The simulations were conducted for four different acceleration air heights and different percentages of separator protrusion.
x. The changes in the acceleration air height changed the velocity ratio of the acceleration air and the main air.
xi. One simulation was conducted without a separator. The other simulations were conducted with acceleration air heights of 50 mm, 75 mm, 100 mm and 200 mm, and acceleration air velocities of 16 m/s, 10.67 m/s, 8 m/s, and 4 m/s, respectively.
xii. The experiment was conducted for gas-particle processors with one curtain only.
xiii. The process parameters of the simulation are shown in Table 1 below.

TABLE 1
Process parameters of the CFD simulation of Experiment 1.

| | |
|---|---|
| Contactor width (m) | 0.5 |
| Total height of duct (m) | 1.003 |
| Separator thickness (m) | 0.003 |
| Acceleration air height (m) | 0.05, 0.1 and 0.2 |
| Main air height (m) | 0.8, 0.9 and 0.95 |
| Separator protrusion (%) | 0, 20, 40, 60, 80, 100 |
| Acceleration air flow (kg/s) | 0.784 |
| Main air flow (kg/s) | 0.35 |
| Total air flow (kg/s) | 1.13 |
| Inlet airflow temperature (K) | 405 |
| Feeder length (m) | 0.2 |
| Mass flow solids (kg/s) | 1 |
| Volumetric velocity (mm/s) | 3.9 |
| Particle size (m) | 0.00028-0.0004(rosin |
| | rammler mean at 0.00034) |
| Particle density (kg/m³) | 2540 |
| Specific heat (J/kg · K) | 1047-1769 |

### Experiment 2

Experimental work in relation to the present invention was carried out by the applicant to demonstrate that the compactness of the invention can be improved using a bi-directional cross-flow system.

Details of the experimental work is summarised below:
I. The experiment was conducted using Computational Fluid Dynamics (CFD) modelling software.
II. The CFD modelling software simulated a specified sensible heat transfer application involving a stream of hot air as the total gas stream and a stream of seed particles as the particle stream.
III. The gas-particle processor was modelled as a single duct with a height of 5 m, a length of 1 m, and a width of 0.15 m.
IV. The duct was separated into two cross-flow sections each with a height of 2.5 m.
V. The acceleration air height was defined as the height above the separator at which the acceleration air was supplied.
VI. The mass flow rate of the particle stream was kept constant at 0.3 kg/s.
VII. The process parameters of the simulation are shown in Table 2 below.

TABLE 2
Process parameters of the CFD simulation of Experiment 2.

| | |
|---|---|
| Number of crossflow sections | 2 |
| Gas | Air |
| Inlet temperature gas(° C.) | 60 |
| Inlet temperature seeds (° C.) | 15 |
| Contactor total height (m) | 5 |
| Contactor width (m) | 0.15 |
| Contactor length (m) | 1 |
| Acceleration air height (m) | 0.15 |
| Height of each crossflow section (m) | 2.5 |
| Feeder length (m) | 1 |
| Volumetric velocity (mm/s) | 25 |
| Seed diameter (m) | 0.002 |
| Seed sphericity | 0.8 |
| Seed density (kg/m³) | 800 |
| Seed specific heat (J/kg · K) | 1350 |
| Seed surface area per kg (m²/kg) | 4.24 |

### Experiment 3

Experimental work in relation to the present invention was carried out by the applicant to demonstrate the difference in performance resulting from the use of a separator and a pressure drive device in a contactor forming a single particle curtain.

The simulation uses uniform 0.881 mm Persian clover seeds at 15° C. interacting with 15° C. air. The process parameters of Experiment 3 are shown in Table 8 below.

TABLE 8
Experiment 3 process parameters.
15 C. air

| | | |
|---|---|---|
| Rho | 1.2257 | kg/m3 |
| mu | 1.8E−05 | kg/m · s |

Persian clover properties

| | | |
|---|---|---|
| dp | 0.000881 | m |
| rho | 2000 | kg/m3 |

Flows

| | | |
|---|---|---|
| Mp | 5 | kg/s |
| Mg total | 5 | kg/s |
| Mg acc | 1.6 | kg/s |
| Mg main | 3.4 | kg/s |

Pressure gain

| | | |
|---|---|---|
| Fan 1 | 12 | Pa |

Geometry

| | | |
|---|---|---|
| fl | 0.2 | m |
| W | 0.5 | m |
| Hacc | 0.3 | m |
| Hmain | 2.7 | m |
| Sp | 0.5 | — |

The same bulk flow of air is used for non-separator and separator simulations, with the separator simulation simply distributing the same total flow into two discrete inlet gas flows. An isothermal application was done to minimise any skewing of results that could occur via heat transfer, i.e. gas cooling down and slowing down etc.

### Experiment 4

Experimental work in relation to the present invention was carried out by the applicant to demonstrate the difference in performance resulting from the use of multiple separators and pressure drive devices in a contactor forming a multiple particle curtains.

The simulation interacts 15° C. air with two curtains made up of 2 mm seeds at 15° C. in a multi-stage system with the properties described in Table 9 below.

TABLE 9
Experiment 4 process parameters.
“Seeds” properties

| | | |
|---|---|---|
| dp | 0.002 | m |
| rho | 1100 | kg/m3 |
| cp | 1300 | J/kg · K |

Geometry

| | | |
|---|---|---|
| fl1 | 0.2 | m |
| fl2 | 0.2 | m |
| W | 0.5 | m |
| Hacc | 0.3 | m |
| Hmain | 2.7 | m |
| Sp | 0.1 | — |

15 C. air

| Rho | 1.2257 | kg/m3 | |
|---|---|---|---|
| mu | 1.8E−05 | kg/m · s | |
| | No Seg | Design 1 | Design 2 |

Flows

| Mp(kg/s) | 4 | | |
|---|---|---|---|
| Mg total(kg/s) | 4.5 | | |
| Total gas velocity(m/s) | 2.449 | | |
| Mg acc(kg/s) | N/A | 1 | 1.3 |
| Acc gas velocity(m/s) | N/A | 5.442 | 7.075 |
| Mg main(kg/s) | N/A | 3.5 | 3.2 |
| Main gas velocity(m/s) | N/A | 2.119 | 1.937 |
| Velocity Ratio | N/A | 2.568 | 3.653 |

Pressure gain (Pa)

| | | | |
|---|---|---|---|
| Fan 1 | N/A | 28 | 30 |
| Fan 2 | N/A | 25 | 30 |

Both curtains have upstream and downstream separators, and both have downstream pressure drive devices (fans).

### Experimental Results

### Experiment 1

This CFD study investigated the influence of separator protrusion on several process parameters include heat duty. The clearance angle, encapsulating the separator protrusion and acceleration zone height is inversely proportional to the separator protrusion for a fixed acceleration gas height and feeder length in this study.

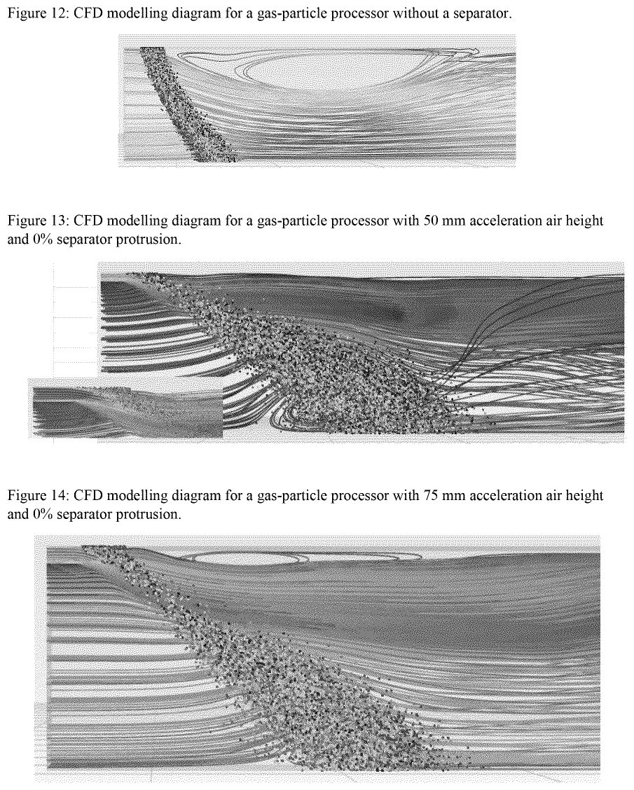

The CFD simulation for a gas-particle processor without a separator included a stream of soda ash particles as the particle stream which was introduced into a gas stream of hot air. There was no separator dividing the gas flow into an acceleration air and a main air. Referring to FIG. 12, the gas flow did not move the curtain effectively horizontally as the flow was induced vertically. As a result, the particles travelled a short distance horizontally and the curtain was not well spread out.

Despite having the same thermal inlet properties of both air flow and particle flow, the heat exchanged was clearly the highest where the separator protrusion was maximised, for all four acceleration air heights.

The experimental results show that a higher separator protrusion percentage increased the trajectory of the curtain which allowed for a higher total surface area of the curtain.

A higher separator protrusion percentage also ensured that acceleration air stayed as horizontal as possible, which means the total surface area of the curtain gets utilised rather than acceleration air flowing “nose-diving” and avoiding sections of the curtain. The nose-diving effect allows the acceleration air to fall through the gap between the separator and curtain.

The highest heat duty recorded was for the acceleration air height of 75 mm, 100% protrusion example, which allowed the main air to be slightly higher than for the 100 mm and 200 mm acceleration air height examples, see Tables 3-5 below. The graph of heat duty vs percentage protrusion for the CFD examples in FIG. 24 shows that the heat duty of the processor increased proportional to the percentage protrusion for all four acceleration air height examples. The heat duty at 0% protrusion was highest for an acceleration air height of 50 mm. The lowest heat duty at 0% protrusion was observed at an acceleration height of 100 mm. However, at higher percentage protrusions, it can be seen from FIG. 24 that the lowest heat duty was for the 200 mm acceleration air height example. At 60% protrusion, the 75 mm example had the highest heat duty of 65,000 W and the second highest heat duty was approximately 64,300 W for the 100 mm example. The lowest heat duty at 60% protrusion was for the 200 mm acceleration air height example. At 100% protrusion, the heat duty for the 75 mm example was around 67,860 W and the heat duty at 100 mm acceleration air height was 66,700 W. This demonstrates that a protruding separator is a beneficial feature.

TABLE 3
Results of the CFD simulation with 75 mm acceleration air height for
different percentages of separator protrusion during Experiment 1.

| Parameter | Units | 0% | 60% | 100% |
|---|---|---|---|---|
| clearance angle | ° | 90.0 | 32.0 | 20.6 |
| main air vel | m/s | 1.95 | | |
| acc air vel | m/s | 10.67 | | |
| mass averaged velocity | m/s | 4.63 | | |
| main air flow | kg/s | 0.784 | | |
| acc air flow | kg/s | 0.35 | | |
| Total air flow | kg/s | 1.13 | | |
| Q | W | 63179 | 64929 | 67859 |
| SA | m2 | 4.39 | 4.69 | 5.11 |
| V | m3 | 0.19 | 0.25 | 0.28 |
| SA/V | m2/m3 | 23.00 | 18.85 | 17.94 |
| min res time | s | 0.42 | 0.44 | 0.49 |
| max res time | s | 0.70 | 0.74 | 0.84 |
| mean res time | s | 0.51 | 0.55 | 0.60 |
| sttdev res time | s | 0.03 | 0.03 | 0.03 |
| Min horizontal flight | m | 0.79 | 1.03 | 1.01 |
| Max horizontal flight | m | 1.94 | 2.62 | 3.41 |
| Spread at outlet | m | 1.15 | 1.58 | 2.40 |
| Outlet solids temp | K | 346 | 349 | 350 |
| Sttdev outlet temp | K | 7.79 | 7.01 | 7.10 |
| Outlet air temp air | K | 350 | 348 | 346 |
| LMDT | K | 60.28 | 58.32 | 56.05 |
| h_surf | W/m2K | 238 | 237 | 237 |
| h_vol | w/m3K | 5485 | 4473 | 4864 |

TABLE 4
Results of the CFD simulation with 100 mm acceleration air height for
different percentages of separator protrusion during Experiment 1.

| | | no- | | | | |
|---|---|---|---|---|---|---|
| Parameter | Units | separator | 0% | 20% | 60% | 100% |
| Clearance angle | ° | | 90.0 | 68.2 | 39.8 | 26.6 |
| Main air vel | m/s | | 2 | | | |
| Acc air vel | m/s | | 8 | | | |
| Mass averaged | m/s | 2.59 | 3.85 | | | |
| velocity | | | | | | |
| Main air flow | kg/s | | 0.784 | | | |
| Acc air flow | kg/s | | 0.35 | | | |
| Total air flow | kg/s | 1.13 | | | | |
| Q | W | 61933 | 61585 | 62144 | 64299 | 66700 |
| SA | m² | 4.68 | 4.26 | 4.29 | 4.68 | 5.10 |
| V | m³ | 0.14 | 0.15 | 0.15 | 0.19 | 0.22 |
| SA/V | m²/m³ | 32.91 | 28.69 | 28.55 | 24.75 | 23.59 |
| min res time | s | 0.45 | 0.41 | 0.41 | 0.45 | 0.50 |
| max res time | s | 0.61 | 0.63 | 0.62 | 0.67 | 0.82 |
| mean res time | s | 0.54 | 0.49 | 0.50 | 0.55 | 0.59 |
| Sttdev res time | s | 0.02 | 0.02 | 0.02 | 0.02 | 0.02 |
| Min horizontal | m | 0.63 | 0.83 | 0.89 | 1.10 | 1.03 |
| flight | | | | | | |
| Max horizontal | m | 1.22 | 1.82 | 1.88 | 2.27 | 3.10 |
| flight | | | | | | |
| Spread at outlet | m | 0.59 | 0.99 | 1.00 | 1.17 | 2.07 |
| Outlet solids | K | 346 | 345 | 346 | 348 | 350 |
| temp | | | | | | |
| Sttdev outlet | K | 7.99 | 7.55 | 7.54 | 6.95 | 6.63 |
| temp | | | | | | |
| Outlet air temp | K | 351 | 351 | 351 | 349 | 347 |
| air | | | | | | |
| LMDT | K | 61.09 | 61.58 | 61.04 | 59.02 | 57.02 |
| h_surf | W/m² · K | 217 | 235 | 237 | 233 | 229 |
| h_vol | W/m³ · K | 7137 | 6729 | 6770 | 5763 | 5410 |
| Useful height | | 0.556 | 0.778 | 0.667 | 0.833 | 0.889 |
| factor | | | | | | |

TABLE 5
Results of the CFD simulation with 200 mm acceleration
air height for different percentages of separator
protrusion during Experiment 1.

| Parameter | Units | 0% | 60% | 80% |
|---|---|---|---|---|
| clearance angle | ° | 90.0 | 59.0 | 51.3 |
| main air vel | m/s | 2.25 | | |
| acc air vel | m/s | 4 | | |
| mass averaged velocity | m/s | 2.79 | | |
| main air flow | kg/s | 0.784 | | |
| acc air flow | kg/s | 0.35 | | |
| Total air flow | kg/s | 1.13 | | |
| Q | W | 61741 | 63254 | 64469 |
| SA | m² | 4.5 | 4.6 | 4.7 |
| V | m³ | 0.120 | 0.129 | 0.138 |
| SA/V | m²/m³ | 37.7 | 36.0 | 34.5 |
| min res time | s | 0.47 | 0.48 | 0.48 |
| max res time | s | 0.59 | 0.66 | 0.81 |
| mean res time | s | 0.53 | 0.54 | 0.55 |
| sttdev res time | s | 0.015 | 0.015 | 0.016 |
| Min horizontal flight | m | 0.60 | 0.55 | 0.44 |
| Max horizontal flight | m | 1.18 | 1.25 | 1.62 |
| Spread at outlet | m | 0.57 | 0.70 | 1.18 |
| Outlet solids temp | K | 345 | 346 | 347 |
| sttdev outlet temp | K | 7.5 | 7.27 | 7.57 |
| Outlet air temp air | K | 351 | 350 | 349 |
| LMDT | K | 61.3 | 60.1 | 59.1 |
| h_surf | W/m²K | 223 | 226 | 228 |
| h_vol | w/m³K | 8399 | 8139 | 7885 |
| Useful height factor | | 0.778 | 0.811 | 0.811 |

However, the percentage of separator protrusion has a limit for each acceleration air height. The particles began to hit the separator after an 80% separator protrusion for the 200 mm acceleration air height. For the 50 mm acceleration air height example, the turbulence became too large with higher percentage protrusions, and the curtain did not perform in cross-flow. As a result, the simulation diverged and no useful data could be extracted. This demonstrates that there is an upper limit on useful protrusion length and percentage protrusion.

The experimental results show that the average residence time was maximised for larger percentages of separator protrusion, refer to Tables 3-5. This may have to do with the mitigation of the nose-diving effect. The acceleration air has a tendency to nose-drive and this influences the y-component of the velocity, particularly on the leading edge of the curtain. The standard deviation of residence time was also increased for larger separator protrusions but was still only ˜5% of residence time.

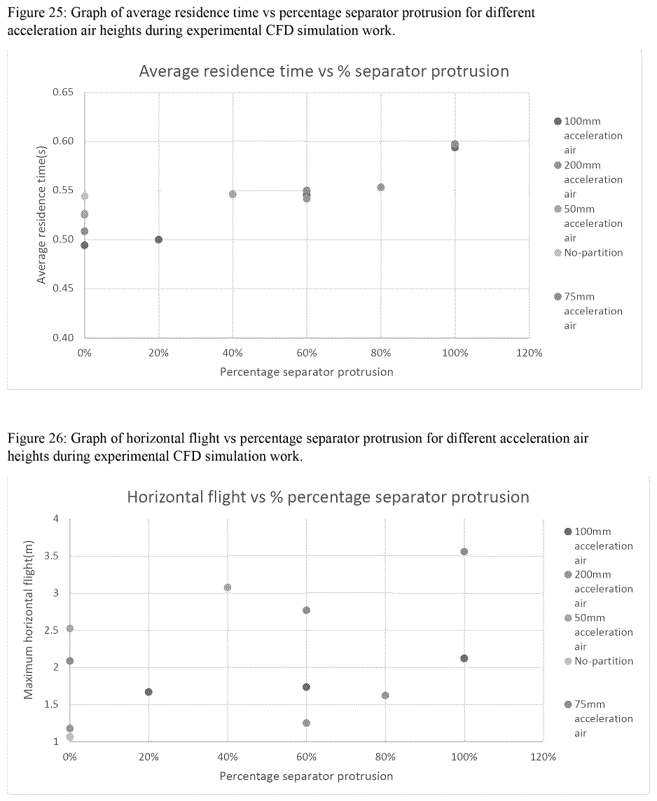

FIG. 25 shows a graph of the average residence time for varying percentage protrusions for the CFD examples without a separator and at 50 mm, 75 mm, 100 mm and 200 mm acceleration air heights. The graph shows that at 0% protrusion, the highest average residence time of the particles is seen for the example without a separator. This may be because without a separator and an acceleration air, the particles in the particle stream do not get accelerated as they fall through the gas flow. The second highest average residence time at 0% protrusion can be seen for the 50 mm acceleration air height example. The average residence time at 0% protrusion was lowest for the 100 mm acceleration air height example. As the percentage protrusion increased, the average residence time at the four acceleration air heights also increased. At 60% protrusion, the highest average residence time can be seen at 75 mm, the second highest average residence time is at 100 mm, and the lowest is at 200 mm. The highest average residence time can be seen on the graph at 100% protrusion for the 75 mm acceleration air height example.

FIG. 28 shows a graph of standard deviation of residence time vs the percentage separator protrusion for the four acceleration air height examples and the example without a separator. The standard deviation of the residence time in the 50 mm example increased as the percentage protrusion increased from 0% to 40%. The standard deviation of the residence time was lower at 60% protrusion for the 75 mm, 100 mm and 200 mm acceleration air height examples. The standard deviation of the residence time at 60% protrusion was highest at 75 mm acceleration air height. The second highest standard deviation at 60% protrusion was seen for the 100 mm example and the 200 mm example had the lowest standard deviation of residence time. At 100% protrusion, the highest standard deviation is seen at the 75 mm acceleration air height, but this was still lower than the standard deviation for the 50 mm example at 40% protrusion. The standard deviation for the 100 mm example also increased as the percentage protrusion increased from 60% to 100%.

The trend in horizontal flight vs percentage separator protrusion for the four acceleration air heights can be seen in FIG. 26. The maximum horizontal flight distance of the acceleration air at 0% protrusion was highest at a value of 2.5 m for the 50 mm acceleration air height example. For the example without a separator, there was only one air flow in the processor it travelled the smallest horizontal distance. The second highest horizontal distance at 0% protrusion was measured for the 75 mm example and the third highest horizontal flight was for the 200 mm example. It can be seen from the graph in FIG. 26 that the horizontal flight of the acceleration air at 100 mm increased as the percentage protrusion increased from 20% to 60% and further to 100%. The shortest horizontal flight distances were seen for the 200 mm acceleration height. This was due to the acceleration air being spread out over a larger height, which reduced the velocity of the acceleration air inducing the air vertically. The highest maximum horizontal flight was seen for the 75 mm example at 100% protrusion as the acceleration air was induced more horizontally along the separator and the velocity of the air was maintained due to the air being spread across a smaller height.

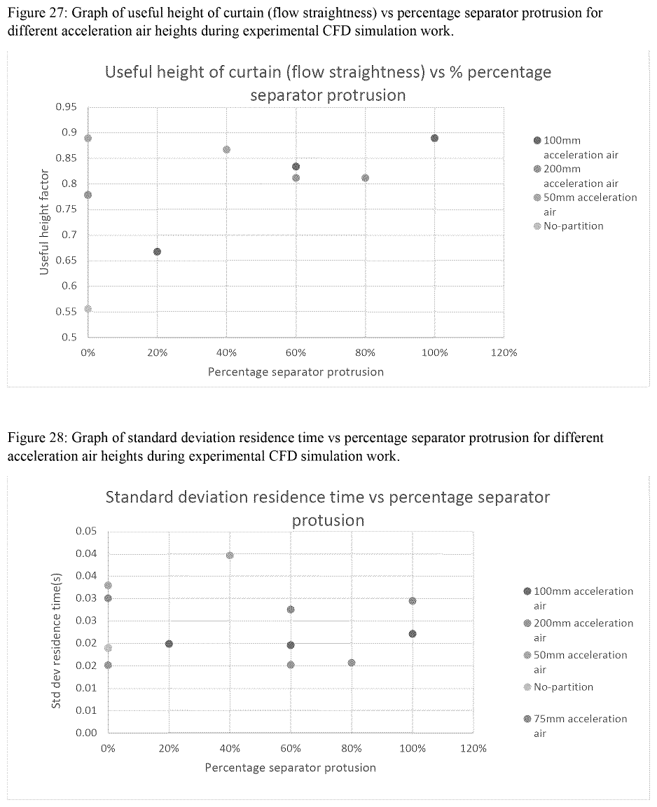

The graph in FIG. 27 shows the useful height of the curtain for the four acceleration air heights for different percentage separator protrusions. The useful height of the curtain or ‘useful height factor’ defines the straightness of the gas flow in the processor. The useful height factor is defined as a measure of how much of the main air flow is in the processing region of the processor. As the main air flows through the processing region, there is a downward force on the main air stream. The useful height factor at 0% protrusion was the lowest with a value of 0.55 for the example without a separator, second highest with a value of 0.778 for the 200 mm acceleration air height example and highest with a value of 0.89 for the 50 mm acceleration air height example. The useful height factor for the 50 mm example was lower with a value of 0.867 when the percentage protrusion was increased from 0% to 40%. For the 100 mm acceleration air height example, the useful height factor was lowest with a value of 0.667 for 20% protrusion. The useful height factor was 0.833 for 60% protrusion and 0.889 for 100% protrusion. As the percentage protrusion increased, the useful height factor increased and straightness of gas flow was achieved. This demonstrates the importance of a separator for allowing a larger portion of the main air stream to be utilised in the processing region.

The curtains which had the higher percentages of separator protrusion travelled the farthest and had the largest spread of curtain at the bottom of the duct. This was expected as the separator protrusion allows better transfer of momentum and a more horizontal contact in the acceleration region. This contrasts with the simulation example without a separator as shown in FIG. 12, which induced a gas flow vertically and did not move the curtain effectively horizontally. This is an important consideration for utilising duct lengths and can affect how many curtains can fit in a fixed duct, especially for taller ducts.

The 50 mm acceleration air height example forced the curtain to travel the farthest as the smaller height and faster velocity acted as a ‘transition point’ for turbulence, see Table 6 below. This forced the curtain into a triangular shape which allowed the curtain to flow more horizontally in the early stages, as shown in FIG. 13. On the other hand, the 200 mm acceleration air height example had the smallest horizontal flight of the acceleration air because the velocity was smaller and spread out over a larger height, leading to a more upright (vertical) initial angle, as shown in FIG. 26.

TABLE 6
Results of the CFD simulation with 50 mm acceleration air height for
different percentages of separator protrusion during Experiment 1.

| Parameter | Units | 0% | 40% |
|---|---|---|---|
| clearance angle | ° | 90.0 | 32.0 |

| | | |
|---|---|---|
| main air vel | m/s | 1.89 |
| acc air vel | m/s | 16 |
| mass averaged velocity | m/s | 6.23 |
| main air flow | kg/s | 0.784 |
| acc air flow | kg/s | 0.35 |
| Total air flow | kg/s | 1.13 |

| | | | |
|---|---|---|---|
| Q | W | 63989 | 65000 |
| SA | m² | 4.48 | 4.66 |
| V | m³ | 0.27 | 0.36 |
| SA/V | m²/m³ | 16.35 | 13.04 |
| min res time | s | 0.40 | 0.42 |
| max res time | s | 0.77 | 0.86 |
| mean res time | s | 0.53 | 0.55 |
| st res time | s | 0.03 | 0.04 |
| Min x | m | 0.89 | 1.29 |
| Max x | m | 2.67 | 3.22 |
| Spread | m | 1.79 | 1.94 |
| outlet temp | K | 347 | 348 |
| st outlet temp | K | 7.84 | 6.20 |
| outlet temp air | K | 349 | 348 |
| LMDT | K | 59.52 | 58.74 |
| h_surf | W/m²K | 240 | 237 |
| h_vol | w/m³K | 3924 | 3096 |
| Useful height factor | | 0.890 | 0.867 |

Typically, the acceleration air height should be minimised to maximise the height of the main air stream. However, there will most likely be a limit where the turbulence and angle are too high which make the curtain too turbulent. This can be seen for the 50 mm acceleration air height CFD diagrams in FIG. 13, especially for the higher percentage separator protrusion.

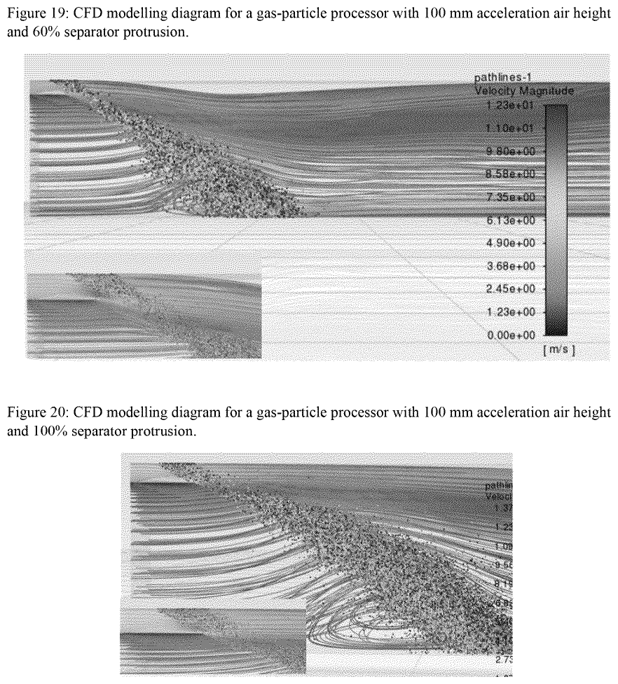

Larger percentages of separator protrusion influenced the CFD-reported flow straightness metric (the useful height of curtain). Higher percentages of separator protrusion resulted in better flow straightness. This was expected as allowing the acceleration air to flow as horizontal as possible mitigates the nose-diving effect of the air and vortex inducing acceleration air from falling vertically upstream of the curtain. This can be seen on the CFD-diagrams shown in FIGS. 12-23.

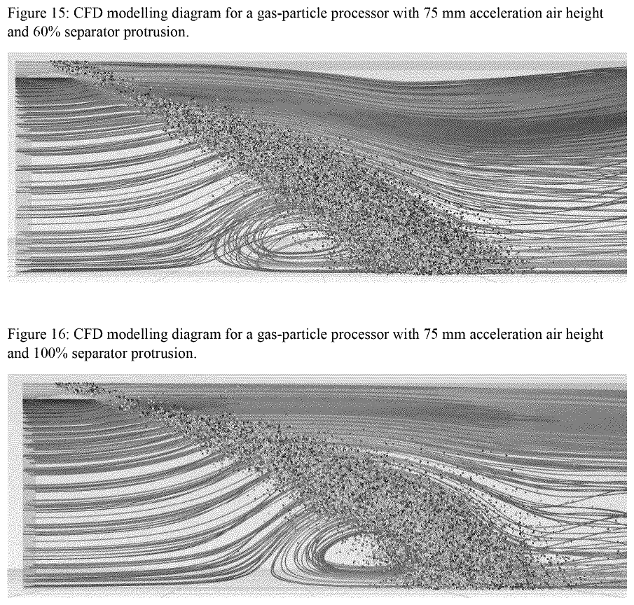

For the 75 mm acceleration air height example, it can be seen from FIG. 14 that the shape of the curtain for a processor with 0% protrusion was similar to that seen in FIG. 13 for the 50 mm example. At 60% protrusion and 75 mm acceleration air height, the curtain had a larger trajectory and travelled a greater distance horizontally as compared to the example with 0% protrusion, refer to FIG. 15. At 100% percentage protrusion, it can be seen from FIG. 16 that the curtain had a good trajectory but the turbulence in the lower region of the curtain increased.

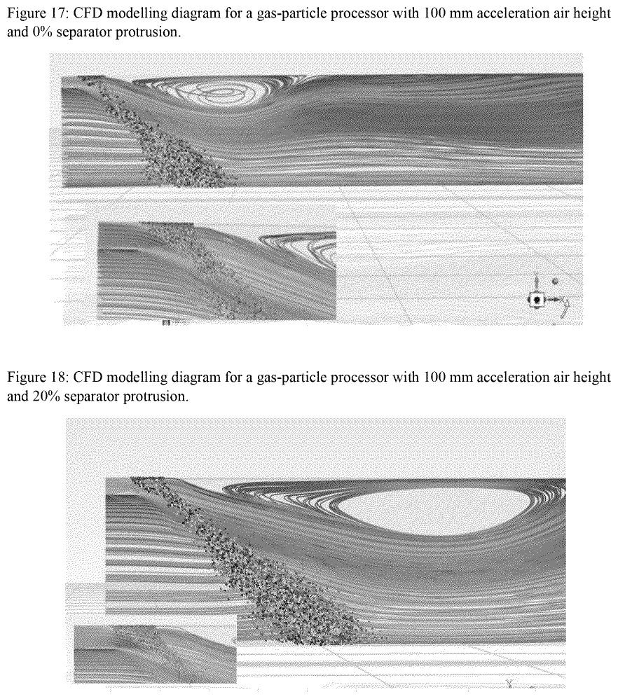

The 100 mm acceleration air height example with 0% protrusion generated a curtain that had a small horizontal distance travelled, see FIG. 17. At 20% protrusion, the horizontal distance that the curtain travelled increased, see FIG. 18. Increasing the percentage protrusion to 60% for the 100 mm example showed that the acceleration air stayed as horizontal as possible utilising the total surface area of the curtain. At 100% protrusion, the acceleration air stayed horizontal after it interacted with the curtain, but the particles in the curtain started to demonstrate turbulent flow in the lower region of the curtain.

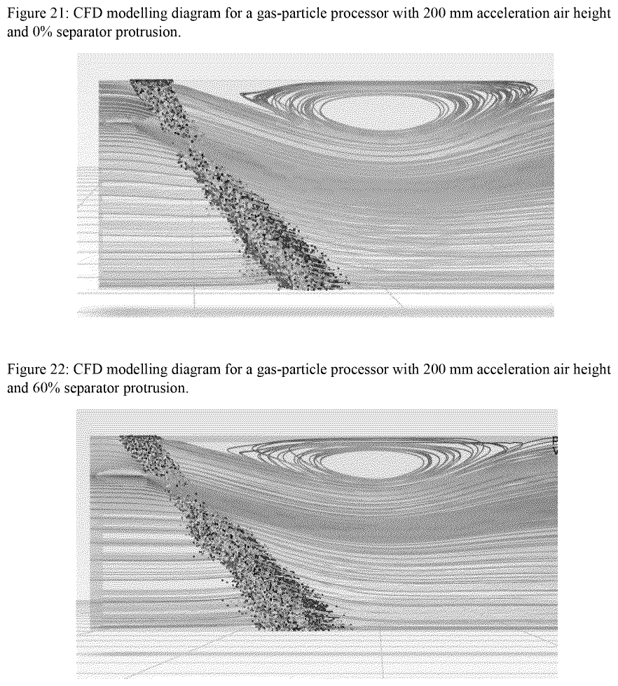

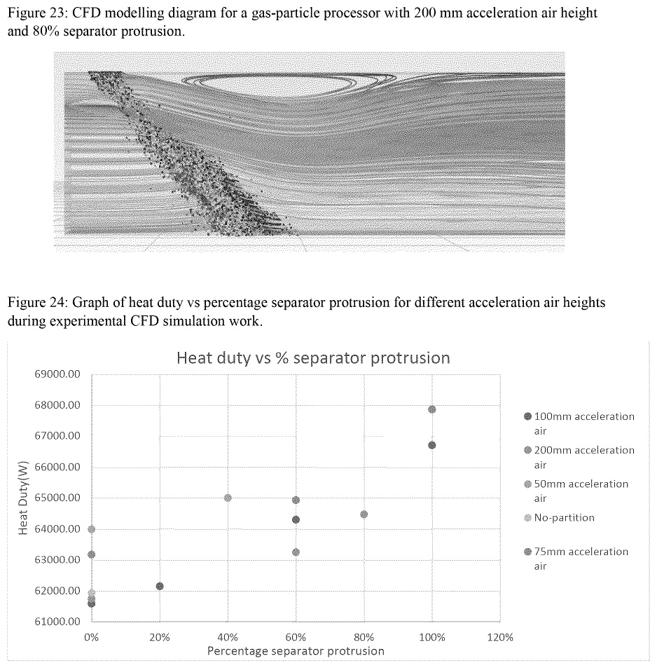

The 200 mm acceleration air height examples show smaller horizontal distances of the acceleration. At 0% protrusion, the acceleration air was seen to be induced vertically initially, see FIG. 21. At higher percentage protrusions, the straightness of the acceleration air flow was improved, as shown in FIG. 23 and FIG. 24.

The percentage of separator protrusion affects the curtain volume in the duct due to two main reasons. Firstly, the separator protrusion increases the trajectory of the curtain, resulting in an increased curtain volume and surface area for a fixed duct height. Secondly, the separator protrusion pushes all of the particles to become more horizontal and can increase the turbulence of the particles. This typically resulted in a lower surface area per unit volume and volumetric heat transfer coefficient for the embodiment with one curtain.

The surface area per unit volume metrics are useful in multi-curtain embodiments. However, if one curtain is required, then surface area per unit volume is not as important as the heat duty, residence time and standard deviation of residence time, etc in the gas-particle processor. Flow straightness also becomes more relevant for multi-curtain embodiments.

Some benefits that are maximised for one curtain may not be as beneficial for multi-curtains. The procedure to identify a preferred design must consider whether a single curtain configuration is practicable before investigating multi-curtain options since downstream flow straightness can be sacrificed if a single curtain system is a viable option. The CFD-based modelling procedure can facilitate the comparison of such options.

The downstream flow straightness can be managed with a fan or other pressure gradient intervention to manage the acceleration air continuing onto the next hypothetical downstream curtain. This feature was not considered in this investigation, but this would be considered to investigate a multi-curtain option.

### Experiment 2

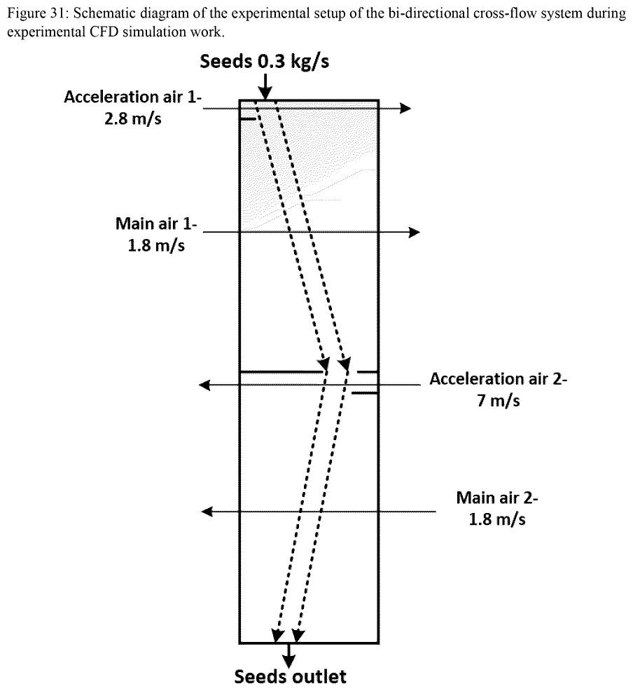

The experimental setup of the bi-directional cross-flow simulation is illustrated in FIG. 31.

Design 1 of the simulation included bi-directional cross-flow with a positioned gap between two-cross flow sections and two acceleration air streams.

Design 2 of the simulation included uni-directional cross-flow with no acceleration air.

Design 3 of the simulation included uni-directional cross-flow with an acceleration air stream and 0% separator protrusion.

The results of the simulation work conducted using the three designs are shown in Table 7 below.

TABLE 7
Results of the CFD simulation with a bi-directional and
a uni-directional cross-flow system during Experiment 2.

| | Design 1 | Design 2 | Design 3 |
|---|---|---|---|
| Mass flow acc air 1(kg/s) | 0.067 | | 0.09 |
| Mass flow main air 1 (kg/s) | 0.671 | | |
| Mass flow acc air 2(kg/s) | 0.168 | | |
| Mass flow main air 2(kg/s) | 0.970 | | |
| Mass flow total air(kg/s) | 1.88 | | |
| Heat Duty(W) | 7591 | 7330 | 7539 |
| Mean residence time(s) | 1.35 | 1.34 | 1.34 |
| Mass in domain(kg) | 0.405 | 0.399 | 0.402 |
| Surface area(m2) | 1.72 | 1.69 | 1.70 |
| Curtain surface/volume | 12.7 | 11.0 | 10.4 |
| Horizontal footprint(m) | ~0.80 | 1.95 | 2.25 |

The experimental results show that using a bi-directional cross-flow system resulted in a reduction in the horizontal footprint of 35% of that of the largest unidirectional cross-flow regime.

The residence time, curtain mass, surface area did not change drastically from bi-directional to unidirectional cross-flow which was expected. However, the surface area was highest in the designs with acceleration air. This allows the curtain to fit in more mass for a fixed duct height.

The heat duty was the highest for the bi-directional cross-flow example. The uni-directional design can be optimised to achieve the same heat duty as that of the bi-directional design, but the benefit in the bi-directional design is that a high heat duty can be achieved in a much smaller footprint. This is the benefit of compactness for a single curtain.

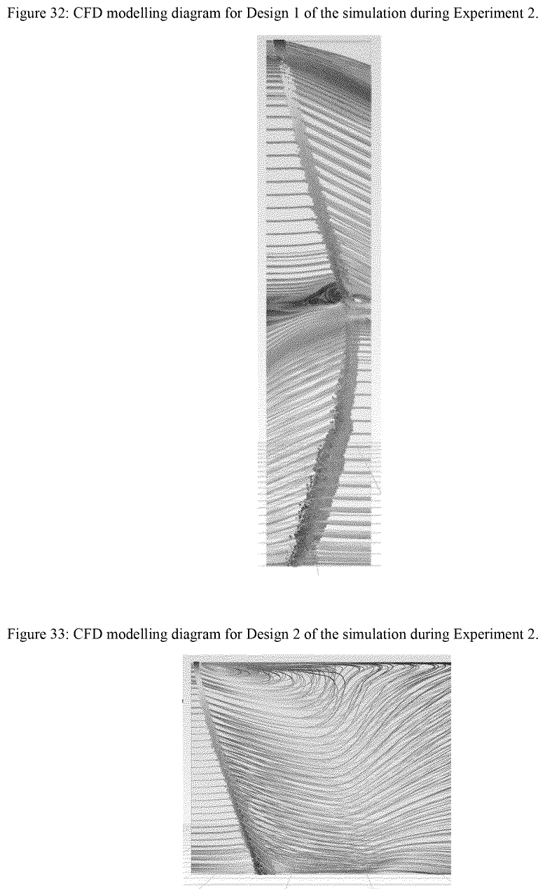

FIG. 32 shows the CFD diagram for Design 1 of the simulation where bi-directional cross-flow was used. The curtain formed in the first cross-flow section was uniform in shape as the particles contacted the main air stream flowing from left to right. The particles then entered the second cross-flow section and were introduced into the second acceleration air stream flowing in the opposite direction from right to left. The shape of the curtain was similar to that of the first cross-flow section.

FIG. 33 shows the CFD diagram for Design 2 of the simulation using unidirectional cross-flow with no acceleration air. As demonstrated in Experiment 1, the particle stream was induced vertically initially. There was only one horizontal gas stream in cross-flow with the particle stream and the curtain formed traveled a short distance horizontally and had a smaller surface area than Design 1.

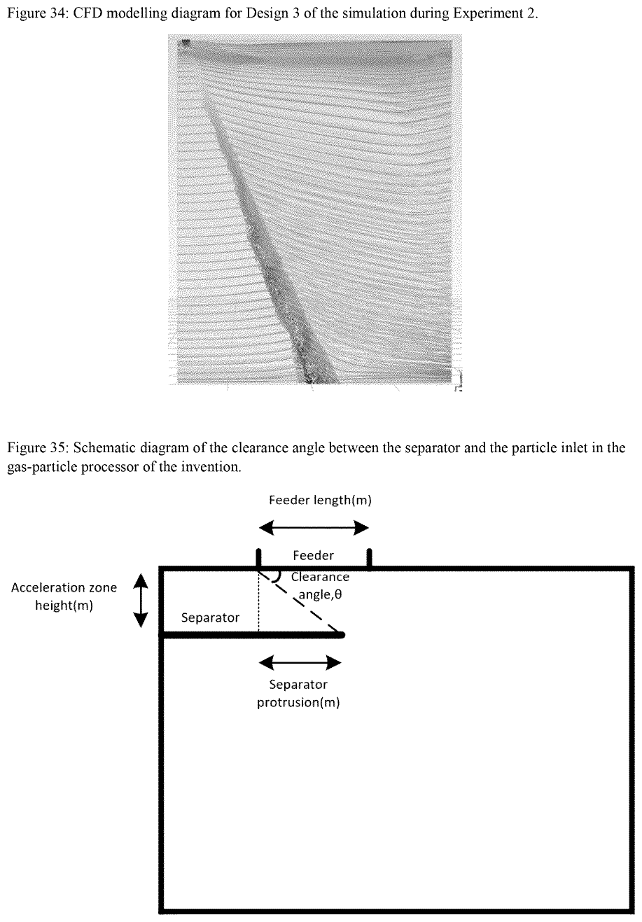

The CFD diagram for Design 3 of the simulation using unidirectional cross-flow with an acceleration air stream is shown in FIG. 34. The separator did not protrude the length of the particle feeder or particle inlet. The curtain formed for Design 3 had a larger spread than that shown in FIG. 33 for Design 2. The curtain had a larger surface area when compared to Design 2 and the largest footprint among the three designs.

Whilst the experimental work was conducted using CFD-modelling software, the applicant believes that the same or similar results would be obtained if carried out in a pilot-plant on a larger scale.

Modelling work carried out by the applicant indicates that the experimental data for the soda ash particles tested can be extrapolated to other particles.

### Experiment 3

The results summarised in Table 10 below outline the mean residence time, dimensionless variance of the particles and average slip velocity on Persian clover seeds once the curtain reaches steady state. The slip velocity was calculated from the particle Reynolds number extracted from CFD.

TABLE 10
Experiment 3 results.

| | 1 Curtain | | |
|---|---|---|---|
| | No | With | With separators and |
| | separators | separators | pressure drive |
| Mean res time(s) | 0.884 | 0.867 | 0.886 |
| St dev(s) | 0.0247 | 0.0224 | 0.0225 |
| Var(s\hat{ }2) | 0.0006 | 0.0005 | 0.0005 |
| Dimensionless | 0.00078 | 0.00067 | 0.00065 |
| variance | | | |
| Average slip | 3.198 | 4.047 | 4.050 |
| velocity (m/s) | | | |

It was observed that both the dimensionless variance of the particles and average slip velocity were improved by using a separator with two discrete flow velocities. Furthermore, the highest mean residence time, best dimensionless variance of the particles and highest average slip velocity occurred when there was a pressure drive in the downstream section of the acceleration gas line (which is only possible with upstream and downstream separators).

A likely reason for the increased average slip velocity is a more perpendicular behaviour of the crossflow gas onto the falling particles. This can be illustrated using geometry and the slip velocity equation below, which is the magnitude of the velocity differences of the particle relative to the gas.

$${U}_{slip} = \sqrt{{( {U}_{p , x} - {U}_{g , x} )}^{2} + {( {U}_{p , y} - {U}_{g , y} )}^{2} + {( {U}_{p , z} - {U}_{g , z} )}^{2}}$$

x is horizontal dimension (e.g. length) of the chamber, y is vertical dimension (e.g. height) of the chamber, and Z is width dimension of the chamber.
Xₛₗᵢₚ is maximised when the gas streamlines are perpendicular to the particle flow, i.e. when the x term for the particles is as close to 0 as possible while the gas x velocity is improved.
Yₛₗᵢₚ is maximised when the gas streamlines have a vertical downward velocity as close to 0 as possible while the particles fall under gravity.
Z term assumed to be negligible.

Without a separator, the gas streamlines become more parallel with the particles as the particles induce the gas flow down with them (reducing the Yₛₗᵢₚ term). The separators with the pressure drive devices help keep the bulk gas flow as perpendicular as possible, leading to a higher average slip velocity.

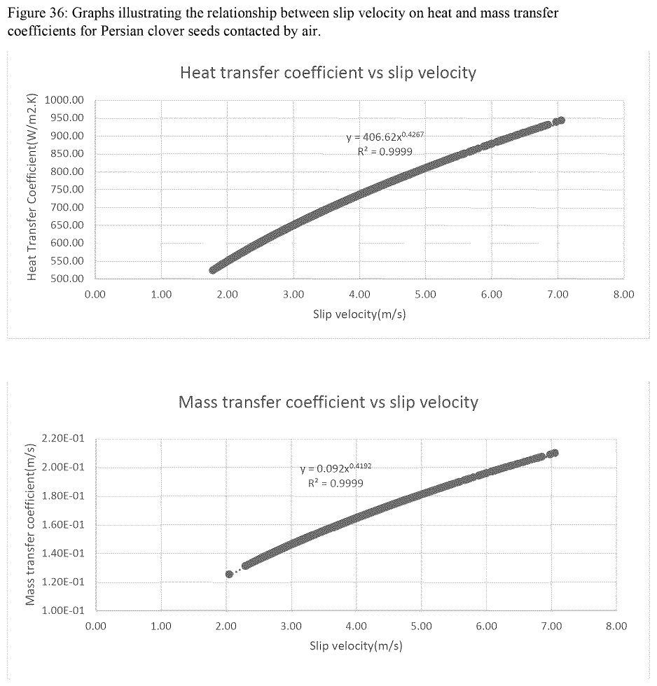

The graphs in FIG. 36 are for the particles quoted in the investigation contacted by 15° C. air isothermally, and illustrate the relationship between slip velocity and heat transfer coefficient and mass transfer coefficient for Persian clover seeds. FIG. 36 shows that slip velocity greatly influences heat and mass transfer and optimising the slip velocity on the particles in the curtain will improve the contacting performance in crossflow.

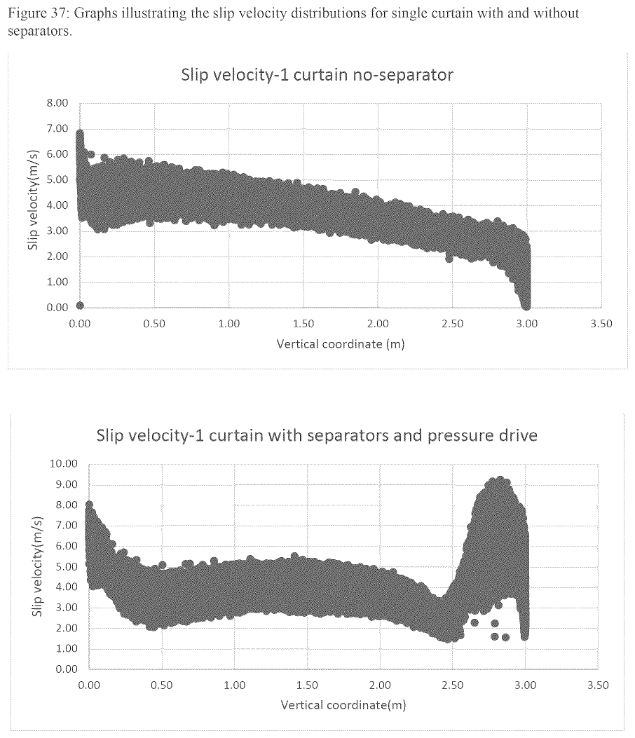

FIG. 37 shows the effect of a separator on the slip velocity with a surge in the slip velocity to about 9 m/s at a vertical coordinate of about 2.75 m.

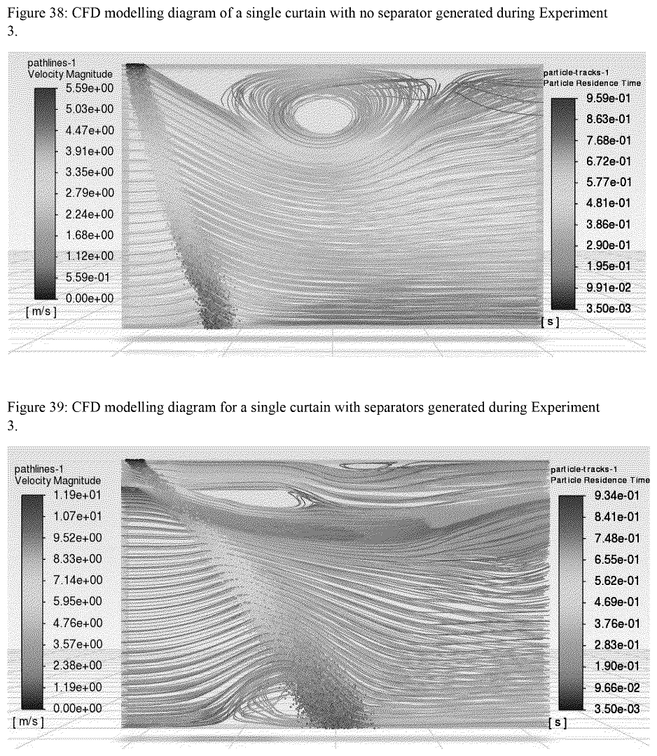

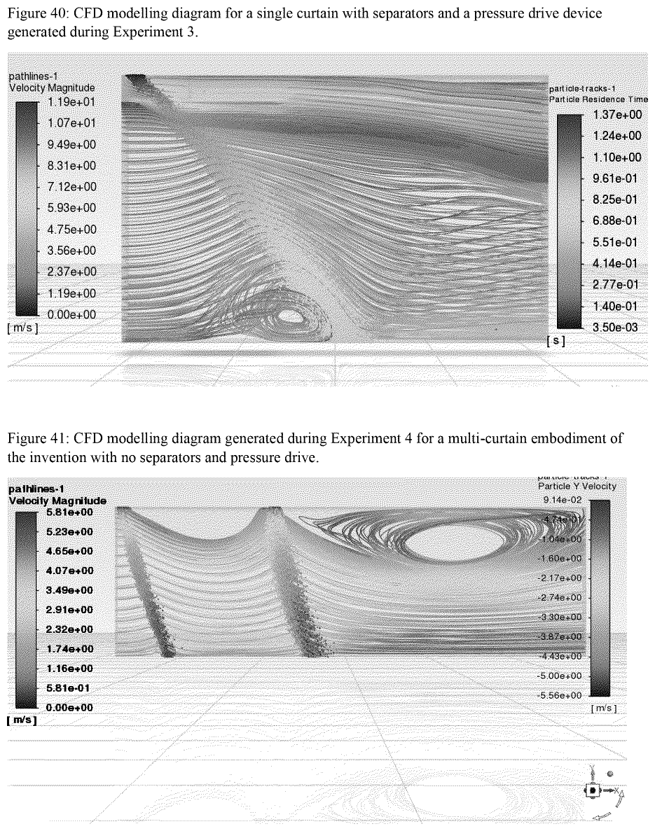

FIGS. 38 to 40 are CFD diagrams which show the effect of separators and pressure drive devices on particle flow profile.

In summary, the following observations were made:
The dispersion of particles based on the dimensionless variance of the particles for the separator and the separator and pressure drive device experiments provided a 15-17% improvement compared with the no separator experiment.
The average slip velocity, which controls the rate of heat and mass transfer at the particle surface is up to 26% higher. The relationship between slip velocity and heat and mass transfer coefficients universally follows a power law (for a particular particle size and gas properties), that is relatively linear in the region where typical slip velocities exist. Therefore, a similar increase to the Nusselt and Sherwood numbers of results in a close to linear increase in heat and mass transfer coefficients with respect to the slip velocity.
It is more energy efficient to accelerate only a portion of the cross-sectional area of the chamber rather than the whole chamber cross-section (assuming the compared curtains have the same trajectory).
It is more compact to use separators and pressure drive devices in a multi-stage processor by minimising the chamber volume consumed by downstream vortexes.
The dimensionless variance of the particles for one curtain can be conserved for proceeding curtains and the total process of n curtains.

### Experiment 4

FIG. 41 is a CFD diagram for a multi-curtain embodiment of the invention with no separators and pressure drive.

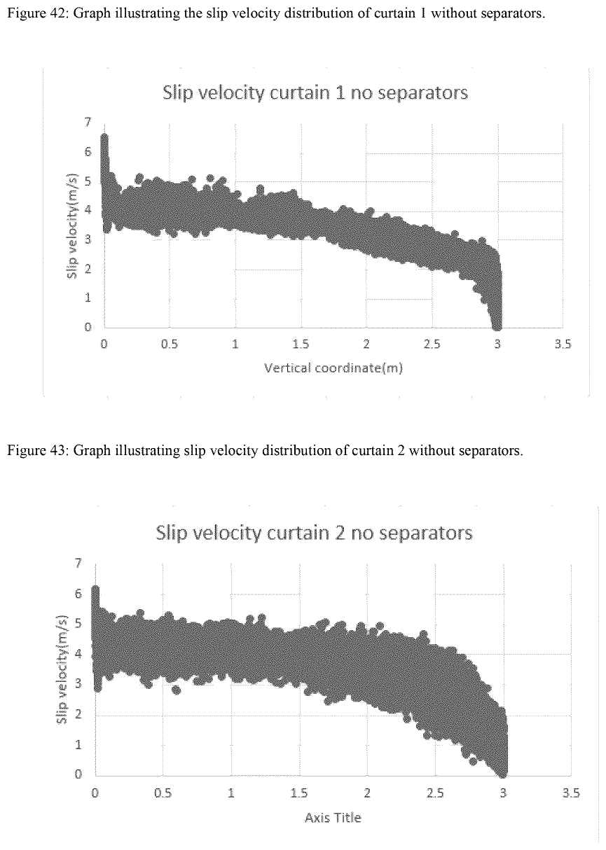

FIG. 42 shows the slip velocity distribution of curtain 1 and FIG. 43 shows the slip velocity profile of curtain 2 in the absence of separators.

Table 11 provides the average slip velocities for the curtains in a two-stage processor according to the present invention. The velocities were calculated from the particle Reynolds number extracted from CFD.

TABLE 11
Average slip velocity from Experiment 4.
Average slip velocity(m/s)

| | Curtain 1 | Curtain 2 |
|---|---|---|
| Without separators | 3.033 | 3.112 |
| With separators and | 3.879 | 3.645 |
| pressure drives | | |

It was observed that without a separator and pressure drive, both curtains have a lower slip velocity compared to when a separator with pressure drive device was used. This is consistent with the applicant's findings that the use of a separator optionally with a pressure drive device maximises slip velocity.

Two different designs (i.e. Designs 1 and 2) were developed for the systems with separators and pressure drive devices. Parameters for both Designs are provided in Table 9.

TABLE 12
Residence time distribution and average slip velocity
data for two-curtain simulations from Experiment 4.

| | | |
|---|---|---|
| Curtain1 | Curtain 2 | Total |

Without separators

| | | | |
|---|---|---|---|
| Mean residence time(s) | 0.890 | 0.928 | 1.818 |
| Standard Deviation(s) | 0.0195 | 0.0501 | 0.0696 |
| Variance(s\hat{ }2) | 0.000379 | 0.00251 | 0.00484 |
| % Standard deviation of mean | 2.189 | 5.395 | 3.827 |
| residence time | | | |
| Dimensionless Variance | 0.000479 | 0.00291 | 0.00146 |
| Average slip velocity(m/s) | 3.033 | 3.112 | |

With separators and pressure drives Design 1

| | | | |
|---|---|---|---|
| Mean residence time(s) | 0.871 | 0.882 | 1.752 |
| Standard Deviation(s) | 0.0157 | 0.0314 | 0.0472 |
| Variance(s\hat{ }2) | 0.000247 | 0.000989 | 0.00223 |
| % Standard deviation of mean | 1.81 | 3.57 | 2.69 |
| residence time | | | |
| Dimensionless Variance | 0.000326 | 0.00127 | 0.000725 |
| Average slip velocity(m/s) | 3.476 | 3.373 | |

With separators and pressure drives Design 2

| | | | |
|---|---|---|---|
| Mean residence time(s) | 0.862 | 0.875 | 1.738 |
| Standard Deviation(s) | 0.0187 | 0.0267 | 0.0454 |
| Variance(s\hat{ }2) | 0.00035 | 0.000714 | 0.00206 |
| % Standard deviation of mean | 2.170 | 3.052 | 2.614 |
| residence time | | | |
| Dimensionless Variance | 0.000471 | 0.000931 | 0.000683 |
| Average slip velocity(m/s) | 3.625 | 3.404 | |

Table 12 shows that for a multi-stage system with separators and pressure drives, the dimensionless variance of the particles for the second curtain is increased by a factor of 6, and the overall residence time dimensionless variance of the particles increases by about a factor of 3. This means the residence time deteriorates with an increasing number of particle curtains and it becomes difficult to control and reproduce.

When the separators and pressure drive devices are put in place, a more reproducible residence time control between curtain 1, curtain 2, and the overall process was observed.

Design 1 shows a dimensionless variance of the particles in curtain 1 of 0.000326 and overall system dimensionless variance of the particles of 0.0007248, which is a loss in the tightness by close to a factor of 2.

However, in Design 2, the dimensionless variance of the particles goes from 0.000471 to 0.0006834, or a loss in tightness of about a factor of 1.45. This is an improvement over Design 1. The acceleration gas and main gas flows coupled with the separators and pressure drives allow the total dimensionless variance of the particles for the system to be managed and confirms that the dimensionless variance of the particles for the first curtain can be carried over for n-curtains in some cases.

Another benefit of utilising multiple separators and pressure drive devices is a reduction of the space occupied by multi-curtains. There are a number of reasons for this.

Firstly, the multiple separators and pressure drive devices mitigate the formation of downstream vortexes.

Secondly, although the particle curtains formed with gas-particle processors having separators and pressure drive devices have a longer trajectory, they allow the particle curtains to be formed closer together.

One problem faced by separator-less gas-particle processor is that placing the second sequential curtain too close to the first curtain (right in the middle of the vortex), would induce a sharp upward flow of the gas on the upstream edge of the second curtain, then a very strong downward current through the second curtain. This increases turbulence of the second curtain and disturbs the residence time distribution and distribution of slip velocity values.

A second particle feeder can be utilised to introduce particles into the chamber. The second particle feeder may be in fluid communication with a particle outlet to re-introduce a particle stream into the chamber. When separators and pressure drive devices are utilised, the second particle feeder can be placed much closer to the first particle feeder and reducing the overall length of the chamber.

The combination of improved slip velocity and ability to place particle feeders closer together results in an increase in the volumetric heat transfer coefficient per chamber volume.

Design 2 had the best overall residence time distribution and average slip velocity figures but had the bigger difference in slip velocity between curtain 1 and curtain 2 than Design 1. This is likely because the two curtains in Design 2 have different trajectories and did not have the acceleration gas managed effectively to be able to penetrate the first curtain and continue onto the second curtain.

It was also observed that the impact of curtains 1 and 2 are different between Designs 1 and 2 with respect to the slip velocity distributions.

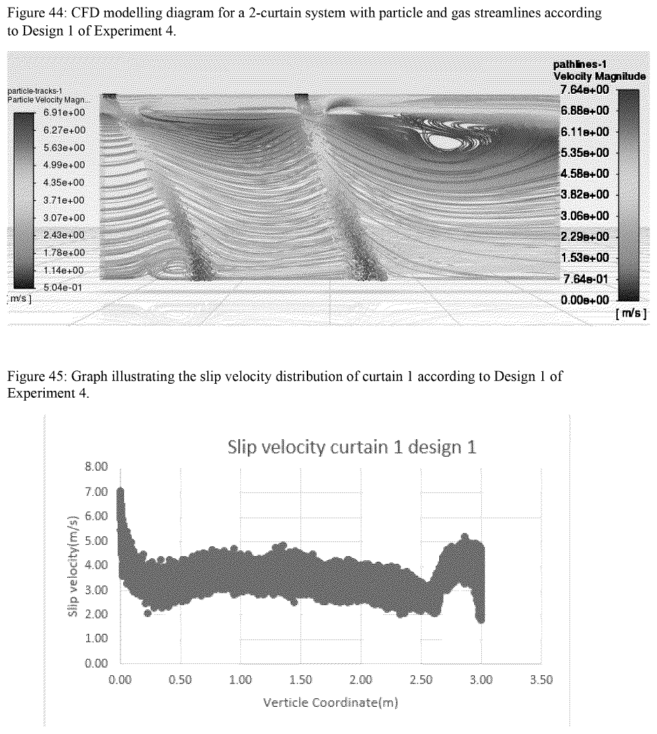

FIG. 44 is a CFD modelling diagram for a 2-curtain system with particle and gas streamlines and FIG. 45 is a graph illustrating the slip velocity distribution of curtain 1 according to Design 1.

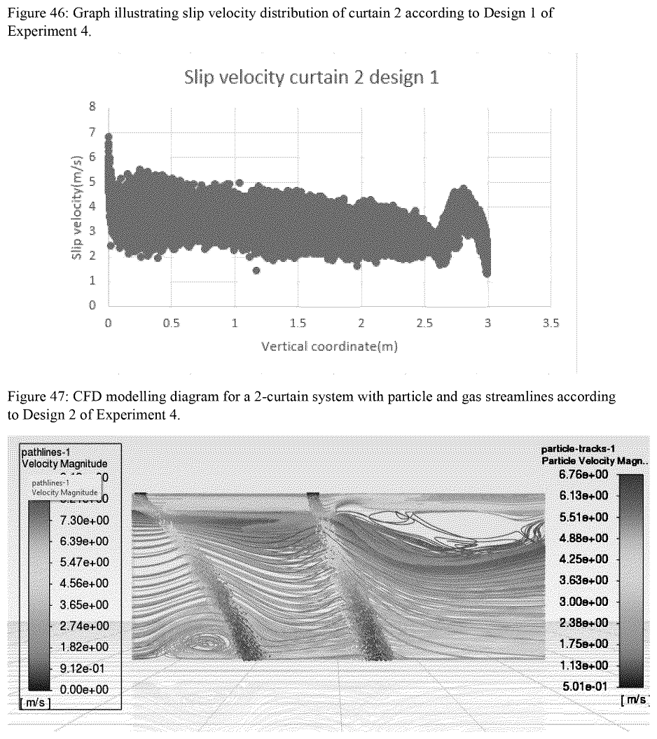

FIG. 45 shows the slip velocity distribution of curtain 1 and FIG. 46 shows the slip velocity profile of curtain 2 according to Design 1. A key effect of a separator on the slip velocity distribution of a particle curtain is a surge in the slip velocity at the separator. In FIGS. 45 and 46, this surge is observed at a vertical coordinate of around 2.5 m.

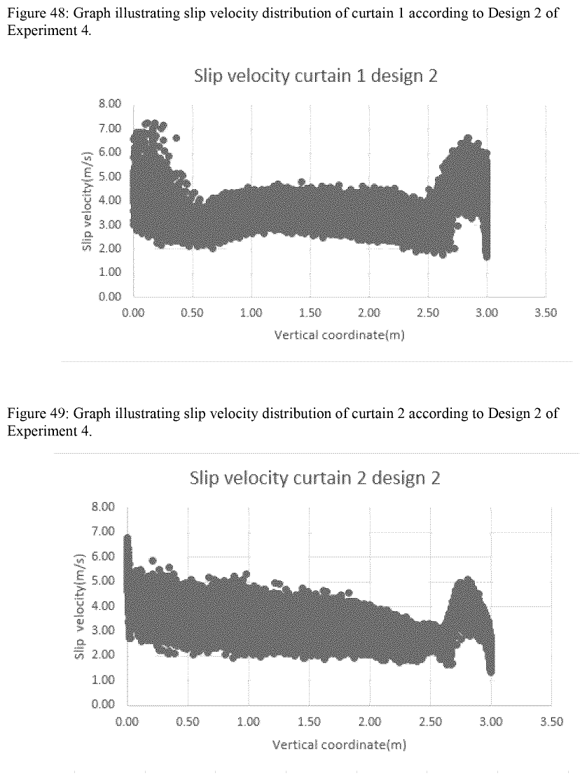

FIG. 47 is a CFD modelling diagram for a 2-curtain system with particle and gas streamlines according to Design 2 of Experiment 4. FIGS. 48 and 49 are graphs illustrating the slip velocity distribution of curtains 1 and 2 according to Design 2 of Experiment 4, respectively.

Design 1 has a lower acceleration gas velocity so its slip velocity in the acceleration gas zone is lower, leading to a “flatter” distribution, while Design 2 uses a higher acceleration gas velocity, and therefore has a more “parabolic” slip velocity distribution. This observation is more visible in curtain 1 for both cases, while curtain 2 has a larger distribution of slip velocities due to the turbulence generated from curtain 1.

The simulations and results from Experiment 4 demonstrate the following outcomes:
1. Separators and pressure drives are beneficial to multi-stage operation because it maximises the slip velocity.
2. Separators improve the overall tightness of residence time (via the dimensionless variance metric) of the total process (n curtains).
3. Dimensionless variance of the particles values extracted from single stage simulations, can be used for n number of curtains.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A gas-particle processor for contacting a particle stream with a gas stream comprising:
a chamber;
at least one gas inlet to introduce gas into the chamber, the gas forming an acceleration gas stream and a main gas stream in the chamber;
a particle feeder in fluid communication with a particle inlet to introduce a particle stream into the gas; and
a separator to separate the acceleration gas stream from the main gas stream in at least part of the chamber, wherein the acceleration gas stream has a higher average velocity than the main gas stream to form a curtain of the particle stream having an upstream edge and a downstream edge; and
a particle outlet for receiving the curtain of the particle stream.

2. The processor of claim 1 configured such that the curtain of the particle stream has an at least 5% reduction in the dimensionless variance of residence time of the particles compared to a curtain of the particle stream formed in a gas-particle processor without a separator.

3. The processor of claim 1 configured to achieve an average slip velocity of at least 10% higher compared to a gas-particle processor without a separator.

4. The processor of claim 1, wherein at least one gas inlet is configured to introduce gas in a substantially horizontal direction into the chamber.

5. The processor of claim 1, wherein the particle inlet is configured to introduce a particle stream in a substantially vertical direction into the gas stream.

6. The processor of claim 5, wherein the particle inlet is configured to deliver the particle stream into the acceleration gas stream.

7. The processor of claim 1 configured such that less than 10 wt % of the particle stream contacts the separator.

8. The processor of claim 1 comprising a solid separator.

9. The processor of claim 1 comprising a perforated separator.

10. The processor of claim 1 including at least two pairs of particle inlets and outlets, wherein the first particle outlet is in fluid communication with the second particle inlet.

11. The processor of claim 10, wherein a separator is located upstream or downstream of a particle outlet.

12. The processor of claim 1 comprising a pressure drive device for introducing a positive pressure in the acceleration gas stream.

13. The processor of claim 1 wherein the separator is positioned to provide a clearance angle that is greater than 20°.

14. A method of contacting a particle stream with a gas in a chamber, including:
(i) introducing the gas into the chamber, at least part of the gas forming an acceleration gas stream and a main gas stream in the chamber, wherein the acceleration gas stream has a higher average velocity than the main gas stream; and
(ii) introducing the particle stream into the gas and forming a curtain of the particle stream having an upstream edge and a downstream edge.

15. The method of claim 14, including controlling the gas stream into the chamber such that the curtain of the particle stream has an at least 5% reduction in the dimensionless variance of residence time compared to a curtain of the particle stream formed in a gas-particle processor without a separator.

16. The method of either claim 14, including controlling one or more of gas stream velocity, particle stream velocity, position and size of separator and chamber dimension to achieve an average slip velocity of at least 10% higher compared to a gas-particle processor without a separator.

17. The method of claim 14, including controlling one or more of gas stream velocity, particle stream velocity, position and size of separator and chamber dimension such that less than 10 wt % of the particle stream contacts the separator.

18. The method of claim 14, including introducing the gas stream in a substantially horizontal direction into the chamber.

19. The method of claim 14, including introducing particle stream in a substantially vertical direction into the gas stream.

20. The method of claim 19, including introducing the particle stream into the acceleration gas stream.

21. (canceled)
